(19) United States
(12) Patent Application Publication
(10) Pub. No.: US 2024/0313838 A1
(43) Pub. Date: Sep. 19, 2024

(54) TECHNIQUES FOR CHANNEL STATE INFORMATION AND CHANNEL COMPRESSION SWITCHING

(71) Applicant: QUALCOMM INCORPORATED, San Diego, CA (US)

(72) Inventors: Liangming WU, Beijing (CN); Hao XU, Beijing (CN); Chenxi HAO, Beijing (CN); Qiaoyu LI, Beijing (CN); Rui HU, Beijing (CN); Kangqi LIU, San Diego, CA (US); Wei XI, Beijing (CN); Yu ZHANG, San Diego, CA (US)

(21) Appl. No.: 18/546,926

(22) PCT Filed: Apr. 30, 2021
(86) PCT No.: PCT/CN2021/091734

§ 371 Date: Aug. 17, 2023

(51) Int. Cl. H04B 7/06

(52) U.S. Cl. CPC H04B 7/0626; H04B 7/0658

(57) ABSTRACT

Methods, systems, and devices for wireless communications are described. A wireless communications system may support compression of channel information (e.g., channel feedback) in accordance with multiple compression schemes, from which a transmitting device may select for a channel reporting transmission. For example, a user equipment (UE) may be configured with multiple channel state information compression schemes, corresponding to different encoders or decoders, which may involve various machine learning or neural network techniques. The UE may select or otherwise determine which compression scheme to use for channel reporting in various scenarios, including a selection based on whether a compression scheme maintains relatively accurate reporting, or whether a more power-intensive or processor-intensive compression scheme is supported by an operating mode of the UE, among other selection criteria. The UE may indicate which compression scheme was selected by a transmitted indication included with or otherwise accompanying a channel reporting transmission.

### CROSS REFERENCE

The present application is a 371 national stage filing of International PCT Application No. PCT/CN2021/091734 by WU et al. entitled “TECHNIQUES FOR CHANNEL STATE INFORMATION AND CHANNEL COMPRESSION SWITCHING,” filed Apr. 30, 2021, which is assigned to the assignee hereof, and which is expressly incorporated by reference in its entirety herein.

### INTRODUCTION

The following relates to wireless communications, including compression schemes that may be applied to channel state information reporting.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communication at a UE is described. The method may include receiving first signaling indicating a first configuration associated with a first channel state information compression scheme and a second configuration associated with a second channel state information compression scheme. In some examples, the method may further include transmitting, based on receiving the first signaling, second signaling including channel information estimated by the UE and an indication that the channel information is compressed, or is to be decompressed, in accordance with the first channel state information compression scheme, or in accordance with the second channel state information compression scheme, or both.

An apparatus for wireless communication at a UE is described. The apparatus may include a processor and memory coupled to the processor. In some examples, the processor and memory may be configured to receive first signaling indicating a first configuration associated with a first channel state information compression scheme and a second configuration associated with a second channel state information compression scheme. In some examples, the processor and memory may be further configured to transmit, based on receiving the first signaling, second signaling including channel information estimated by the UE and an indication that the channel information is compressed, or is to be decompressed, in accordance with the first channel state information compression scheme, or in accordance with the second channel state information compression scheme, or both.

Another apparatus for wireless communication at a UE is described. In some examples, the apparatus may include means for receiving first signaling indicating a first configuration associated with a first channel state information compression scheme and a second configuration associated with a second channel state information compression scheme. In some examples, the apparatus may further include means for transmitting, based on receiving the first signaling, second signaling including channel information estimated by the UE and an indication that the channel information is compressed, or is to be decompressed, in accordance with the first channel state information compression scheme, or in accordance with the second channel state information compression scheme, or both.

A non-transitory computer-readable medium storing code for wireless communication at a UE is described. The code may include instructions executable by a processor to receive first signaling indicating a first configuration associated with a first channel state information compression scheme and a second configuration associated with a second channel state information compression scheme. In some examples, the code may further include instructions executable by the processor to transmit, based on receiving the first signaling, second signaling including channel information estimated by the UE and an indication that the channel information is compressed, or is to be decompressed, in accordance with the first channel state information compression scheme, or in accordance with the second channel state information compression scheme, or both.

In some examples of the method, apparatuses, and non-transitory computer-readable medium described herein, the first channel state information compression scheme may be or may include a codebook-based channel state information compression scheme and the second channel state information compression scheme may be or may include a neural network-based channel state information compression scheme.

Some examples of the method, apparatuses, and non-transitory computer-readable medium described herein may further include operations, features, means, or instructions for determining, using a neural network associated with the second channel state information compression scheme and based on the channel information, whether to compress the channel information, or to indicate to decompress the channel information, in accordance with the first channel state information compression scheme, or in accordance with the second channel state information compression scheme, or both.

In some examples of the method, apparatuses, and non-transitory computer-readable medium described herein, the first signaling may include a configuration of the neural network for determining whether to compress the channel information, or to indicate to decompress the channel information, in accordance with the first channel state information compression scheme, or in accordance with the second channel state information compression scheme, or both

Some examples of the method, apparatuses, and non-transitory computer-readable medium described herein may further include operations, features, means, or instructions for determining a first mean squared error associated with a compression in accordance with the first channel state information compression scheme, and determining a second mean squared error associated with a compression in accordance with the second channel state information compression scheme. Some examples of the method, apparatuses, and non-transitory computer-readable medium described herein may further include operations, features, means, or instructions for determining, based on a comparison between the first mean squared error and the second mean squared error, whether to compress the channel information, or to indicate to decompress the channel information, in accordance with the first channel state information compression scheme, or in accordance with the second channel state information compression scheme, or both.

Some examples of the method, apparatuses, and non-transitory computer-readable medium described herein may further include operations, features, means, or instructions for determining a first compression of the channel information based on the first channel state information compression scheme, and determining a second compression of the channel information based on the second channel state information compression scheme. Some examples of the method, apparatuses, and non-transitory computer-readable medium described herein may further include operations, features, means, or instructions for determining, based on a cross-correlation between the first compression and the second compression, whether to compress the channel information, or to indicate to decompress the channel information, in accordance with the first channel state information compression scheme, or in accordance with the second channel state information compression scheme, or both.

Some examples of the method, apparatuses, and non-transitory computer-readable medium described herein may further include operations, features, means, or instructions for training an encoder based on a first decoder indicated by the first configuration, or on a second decoder indicated by the second configuration, or both and compressing the channel information based on the trained encoder.

Some examples of the method, apparatuses, and non-transitory computer-readable medium described herein may further include operations, features, means, or instructions for determining, based on a power consumption associated with the first channel state information compression scheme, a power consumption associated with the second channel state information compression scheme, or both, whether to compress the channel information, or indicate to decompress the channel information, in accordance with the first channel state information compression scheme, or in accordance with the second channel state information compression scheme, or both.

Some examples of the method, apparatuses, and non-transitory computer-readable medium described herein may further include operations, features, means, or instructions for determining, based on a processing load associated with the first channel state information compression scheme, a processing load associated with the second channel state information compression scheme, or both, whether to compress the channel information, or to indicate to decompress the channel information, in accordance with the first channel state information compression scheme, or in accordance with the second channel state information compression scheme, or both.

A method for wireless communication at a base station is described. The method may include transmitting first signaling indicating a first configuration associated with a first channel state information compression scheme and a second configuration associated with a second channel state information compression scheme. In some examples, the method may further include receiving, based on transmitting the first signaling, second signaling including channel information estimated by the UE and an indication that the channel information is compressed, or is to be decompressed, in accordance with the first channel state information compression scheme, or in accordance with the second channel state information compression scheme, or both.

An apparatus for wireless communication at a base station is described. The apparatus may include a processor and memory coupled to the processor. In some examples, the processor and memory may be configured to transmit first signaling indicating a first configuration associated with a first channel state information compression scheme and a second configuration associated with a second channel state information compression scheme. In some examples, the processor and memory may be further configured to receive, based on transmitting the first signaling, second signaling including channel information estimated by the UE and an indication that the channel information is compressed, or is to be decompressed, in accordance with the first channel state information compression scheme, or in accordance with the second channel state information compression scheme, or both.

Another apparatus for wireless communication at a base station is described. In some examples, the apparatus may include means for transmitting first signaling indicating a first configuration associated with a first channel state information compression scheme and a second configuration associated with a second channel state information compression scheme. In some examples, the apparatus may further include means for receiving, based on transmitting the first signaling, second signaling including channel information estimated by the UE and an indication that the channel information is compressed, or is to be decompressed, in accordance with the first channel state information compression scheme, or in accordance with the second channel state information compression scheme, or both.

A non-transitory computer-readable medium storing code for wireless communication at a base station is described. In some examples, the code may include instructions executable by a processor to transmit first signaling indicating a first configuration associated with a first channel state information compression scheme and a second configuration associated with a second channel state information compression scheme. In some examples, the code may further include instructions executable by the processor to receive, based on transmitting the first signaling, second signaling including channel information estimated by the UE and an indication that the channel information is compressed, or is to be decompressed, in accordance with the first channel state information compression scheme, or in accordance with the second channel state information compression scheme, or both.

In some examples of the method, apparatuses, and non-transitory computer-readable medium described herein, the first channel state information compression scheme may be or may include a codebook-based channel state information compression scheme and the second channel state information compression scheme may be or may include a neural network-based channel state information compression scheme.

In some examples of the method, apparatuses, and non-transitory computer-readable medium described herein, the first signaling may indicate a criteria for determining (e.g., for the UE to determine) whether to compress the channel information, or to indicate to decompress the channel information, in accordance with the first channel state information compression scheme, or in accordance with the second channel state information compression scheme, or both.

In some examples of the method, apparatuses, and non-transitory computer-readable medium described herein, the first signaling may include a configuration of a neural network at the UE for determining whether to compress the channel information, or to indicate to decompress the channel information, in accordance with the first channel state information compression scheme, or in accordance with the second channel state information compression scheme, or both.

Some examples of the method, apparatuses, and non-transitory computer-readable medium described herein may further include operations, features, means, or instructions for training an encoder and a decoder associated with the second channel state information compression scheme. In some examples, the first signaling may indicate a configuration of the trained encoder and a configuration of the trained decoder.

Some examples of the method, apparatuses, and non-transitory computer-readable medium described herein may further include operations, features, means, or instructions for training a first decoder associated with the first channel state information compression scheme and a second decoder associated with the second channel state information compression scheme. In some examples, the first signaling may indicate a configuration of the trained first decoder and a configuration of the trained second decoder.

### BRIEF DESCRIPTION OF THE DRAWINGS

FIG. 1 illustrates an example of a wireless communications system that supports techniques for channel state information and channel compression switching in accordance with one or more aspects of the present disclosure.

FIG. 2 illustrates an example of a wireless communications system that supports techniques for channel state information and channel compression switching in accordance with one or more aspects of the present disclosure.

FIG. 3 illustrates an example for joint training of compression schemes that supports techniques for channel state information and channel compression switching in accordance with one or more aspects of the present disclosure.

FIG. 4 illustrates an example of a process that supports techniques for channel state information and channel compression switching in accordance with one or more aspects of the present disclosure.

FIG. 5 illustrates an example of neural network-based switching that supports techniques for channel state information and channel compression switching in accordance with one or more aspects of the present disclosure.

FIG. 6 illustrates an example of a machine learning process that supports techniques for channel state information and channel compression switching in accordance with one or more aspects of the present disclosure.

FIGS. 7 and 8 show block diagrams of devices that support techniques for channel state information and channel compression switching in accordance with one or more aspects of the present disclosure.

FIG. 9 shows a block diagram of a communications manager that supports techniques for channel state information and channel compression switching in accordance with one or more aspects of the present disclosure.

FIG. 10 shows a diagram of a system including a device that supports techniques for channel state information and channel compression switching in accordance with one or more aspects of the present disclosure.

FIGS. 11 and 12 show block diagrams of devices that support techniques for channel state information and channel compression switching in accordance with one or more aspects of the present disclosure.

FIG. 13 shows a block diagram of a communications manager that supports techniques for channel state information and channel compression switching in accordance with one or more aspects of the present disclosure.

FIG. 14 shows a diagram of a system including a device that supports techniques for channel state information and channel compression switching in accordance with one or more aspects of the present disclosure.

FIGS. 15 through 20 show flowcharts illustrating methods that support techniques for channel state information and channel compression switching in accordance with one or more aspects of the present disclosure.

### DETAILED DESCRIPTION

In some wireless communications systems, devices may perform an estimation of signal propagation conditions between a transmitting device and a receiving device, which may be referred to as channel estimation. For example, one or more components of a base station may transmit a reference signal (e.g., a channel state information reference signal (CSI-RS), a cell-specific reference signal (CRS), or another reference signal of combination of reference signals) which may be monitored for or received by a UE. A receiving UE may perform calculations based on measured or predicted characteristics of the reference signal to support various techniques for channel estimation. In some examples, the receiving UE may transmit (e.g., to the transmitting base station) a report of channel conditions based at least in part on the channel estimation performed by the receiving UE, which may be referred to as a channel state information (CSI) report or other signaling of channel information.

In some examples, CSI reports or related channel information may be compressed or decompressed in accordance with a compression scheme (e.g., a CSI compression scheme), which may reduce a payload or size of a CSI report. For example, a CSI compression scheme may involve an encoder at a transmitting device to compress a channel (e.g., channel information, a channel estimate, a CSI report) before transmission, and decoder at a receiving device to decompress the channel (e.g., as received at the receiving device). In some examples, machine learning techniques may be used to support one or more of such compression schemes, which may include training one or more encoders (e.g., an auto encoder), performing operations for encoding information, training one or more decoders (e.g., an auto decoder), performing operations for decoding information, or any combination thereof. Such machine learning techniques may include one or more neural networks (NNs) that may be implemented at one or both of a transmitting device (e.g., a UE) or a receiving device (e.g., a base station). Neural networks that may support such machine learning techniques for channel compression include fully connected NNs, batch normalization NNs, dropout NNs, convolutional NNs, residual NNs, rectified linear unit (ReLU) NNs, and other types of NNs. In some examples, machine learning for channel compression may include or be referred to as a CSI-net or related variations.

Although machine learning or neural network techniques may be implemented in some CSI compression schemes, in some examples, there may be a mismatch of a channel used for training and a channel used for inference. For example, machine learning techniques may be trained according to a known channel (e.g., lab conditions, known parameters, known hardware characteristics, a particular modeling approach) that may not match the devices or channel statistics for inference (e.g., signal propagation conditions between devices, in a deployment stage), which may be more complicated or may present a risk or uncertainty regarding some machine learning techniques. In some examples, one compression scheme may be unsuitable or otherwise less favorable for reducing reporting payload compared to another compression scheme.

In accordance with one or more aspects of the present disclosure, a wireless communications system may support channel compression in accordance with multiple CSI compression schemes, from which a transmitting device may select for a channel reporting transmission. For example, a UE may be configured with multiple CSI compression schemes (e.g., at least a first CSI compression scheme and a second CSI compression scheme), corresponding to different encoders and decoders. Each of the different CSI compression schemes may have a different configuration, such as a differently trained or configured encoder, a differently trained or configured decoder, or a combination thereof. A UE may be configured for evaluating between the different CSI compression schemes, and accordingly may select or otherwise determine which CSI compression scheme to use for channel reporting in various scenarios (e.g., for encoding or decoding a particular CSI report, which may include a selection without an explicit command from the network to use one CSI compression scheme versus another).

A UE may select between CSI compression schemes based on various criteria, such as whether a compression scheme maintains relatively accurate reporting (e.g., is well-correlated between encoding and decoding, is well-correlated between decoding of one scheme versus decoding of another scheme), or whether a more power-intensive or processor-intensive compression scheme is supported by an operating mode of the UE, among other selection criteria. By implementing one or more of the described techniques for channel compression switching, devices of a wireless communications system may be able to implement channel compression schemes responsive to signal propagation conditions and related channel reports, or in a manner that reduces signaling overhead, or considers power consumption or processing load, among other considerations.

Aspects of the disclosure are initially described in the context of wireless communications systems and various examples for implementing channel compression schemes. Aspects of the disclosure are further illustrated by and described with reference to apparatus diagrams, system diagrams, and flowcharts that relate to techniques for channel state information and channel compression switching.

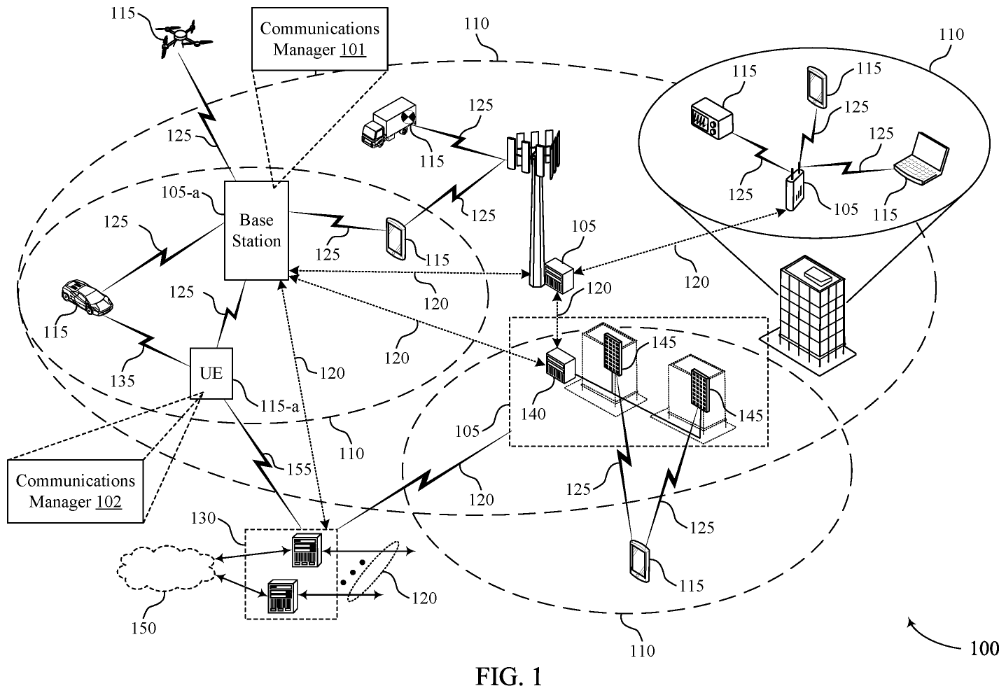

FIG. 1 illustrates an example of a wireless communications system 100 that supports techniques for channel state information and channel compression switching in accordance with one or more aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, an IAB node, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that, although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a CRS, a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, devices of the wireless communications system 100 may perform an estimation of signal propagation conditions between a transmitting device and a receiving device, which may be referred to as channel estimation. For example, one or more components of a base station 105 may transmit a reference signal, such as a CSI-RS or a CRS, which may be monitored for and received by a UE 115. In some examples, the receiving UE 115 may perform calculations based on measured or predicted characteristics of the received reference signal to support various techniques for channel estimation. The receiving UE 115 may transmit (e.g., to the transmitting base station 105) a report of channel conditions based at least in part on the channel estimation performed by the receiving UE 115, which may be referred to as a CSI report. In some examples, generation of CSI reports, or transmission of CSI reports, or reception of CSI reports, or any combination thereof may be performed according to a periodic interval.

In accordance with one or more aspects of the present disclosure, the wireless communications system 100 may support channel compression (e.g., compression of CSI reports or other channel information) in accordance with multiple CSI compression schemes. For example, a UE 115 may be configured with multiple CSI compression schemes, corresponding to different encoders and decoders, and the UE 115 may select or otherwise determine which CSI compression scheme to use for channel reporting in various scenarios (e.g., for encoding a particular CSI report, without an explicit command from a base station 105 to use one CSI compression scheme versus another). The UE 115 may select between CSI compression schemes based on various criteria, such as whether a compression scheme maintains relatively accurate reporting (e.g., is well-correlated between encoding and decoding, is well-correlated between decoding of one scheme versus decoding of another scheme), or whether a more power-intensive or processor-intensive compression scheme is supported by an operating mode of the UE 115, among other selection criteria. By implementing one or more of the described techniques for channel compression switching, devices of a wireless communications system may be able to implement channel compression schemes responsive to signal propagation conditions and related channel reports, and in a manner that reduces signaling overhead, or considers power consumption or processing load, among other considerations.

In some examples, a base station 105-a may include a communications manager 101 that is configured to support one or more aspects of the techniques for channel state information and channel compression switching described herein. For example, the communications manager 101 may be configured to support the base station 105-a transmitting (e.g., to the UE 115-a) first signaling indicating a first configuration associated with a first CSI compression scheme (e.g., a codebook-based CSI compression scheme, a CSI compression scheme configured by parameters of a codebook, a legacy CSI compression scheme, a CSI compression scheme associated with a legacy encoder or decoder, a compression scheme associated with a first granularity or precision) and a second configuration associated with a second CSI compression scheme (e.g., a neural network-based CSI compression scheme, a CSI compression scheme configured using a neural network of the UE 115-a, a CSI compression scheme for evaluation or selection by a neural network of the UE 115-a, a CSI compression scheme associated with an auto decoder or auto encoder having a smaller configuration size, a compression scheme associated with a second granularity or precision). In some examples, the communications manager 101 may be configured to support the base station 105-a receiving, based at least in part on transmitting the first signaling, second signaling comprising channel information estimated by the UE 115-a and an indication that the channel information is compressed or is to be decompressed in accordance with the first CSI compression scheme, or in accordance with the second CSI compression scheme, or both (e.g., as determined or selected by a UE 115-a).

In some examples, a UE 115-a may include a communications manager 102 that is configured to support one or more aspects of the techniques for channel state information and channel compression switching described herein. For example, the communications manager 102 may be configured to support the UE 115-a receiving (e.g., from the base station 105-a) first signaling indicating a first configuration associated with a first CSI compression scheme (e.g., a codebook-based CSI compression scheme, a CSI compression scheme configured by parameters of a codebook, a legacy CSI compression scheme, a CSI compression scheme associated with a legacy encoder or decoder, a compression scheme associated with a first granularity or precision) and a second configuration associated with a second CSI compression scheme (e.g., a neural network-based CSI compression scheme, a CSI compression scheme configured using a neural network of the UE 115-a, a CSI compression scheme for evaluation or selection by a neural network of the UE 115-a, a CSI compression scheme associated with an auto encoder or auto decoder having a smaller configuration size, a compression scheme associated with a second granularity or precision). In some examples, the communications manager 102 may be configured to support the UE 115-a transmitting (e.g., to the base station 105-a), based at least in part on receiving the first signaling, second signaling comprising channel information estimated by the UE 115-a and an indication that the channel information is compressed or is to be decompressed in accordance with the first CSI compression scheme, or in accordance with the second CSI compression scheme, or both (e.g., as determined or selected by the UE 115-a or at the communications manager 102).

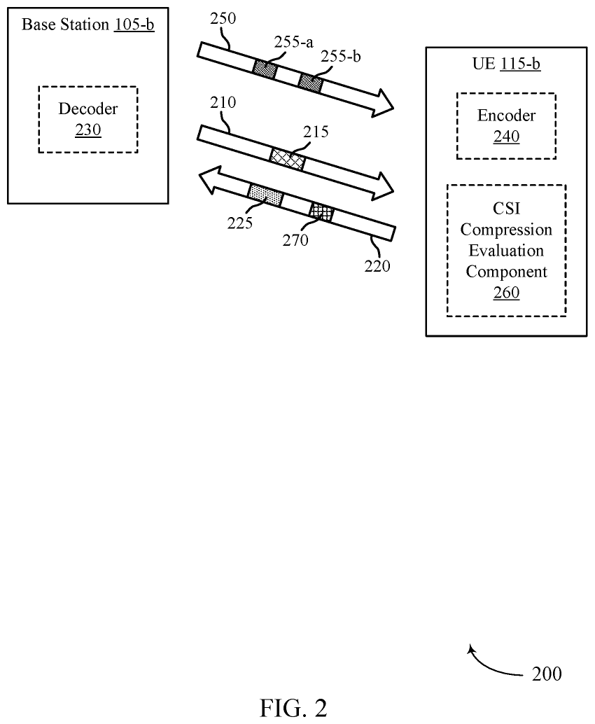

FIG. 2 illustrates an example of a wireless communications system 200 that supports techniques for channel state information and channel compression switching in accordance with one or more aspects of the present disclosure. The wireless communications system 200 illustrates an example of communications between a base station 105-b and a UE 115-b, which may be examples of corresponding devices described herein, including with reference to FIG. 1.

In the example of wireless communications system 200, the UE 115-b, one or more components of the base station 105-b, or both may perform an estimation of signal propagation conditions between the base station 105-b and the UE 115-b, which may be referred to as channel estimation. For example, one or more components of the base station 105-b may transmit downlink signaling 210, which may include a reference signal 215 (e.g., a CSI-RS, or a CRS, or another reference signal or combination of reference signals). The UE 115-b may monitor for such reference signals, and the UE 115-b may perform calculations based on measured or predicted characteristics of the reference signal 215 of the downlink signaling 210 to support various techniques for channel estimation. Based on monitoring for or receiving the reference signal 215, the UE 115-b may transmit uplink signaling 220 (e.g., a responsive uplink transmission), which may be received by the base station 105-b. The uplink signaling 220 may include a CSI report 225, which may be a portion of an uplink control information (UCI) transmission by the UE 115-b (e.g., of a physical uplink control channel (PUCCH)), and may include a report of channel conditions based at least in part on a channel estimation performed by the UE 115-b, or may include measurements or indications of measurements of the reference signal 215 performed by the UE 115-b (e.g., to support a channel estimation calculation by the base station 105-b), among other information or combinations of channel information.

In some examples, a CSI report 225 or related channel information may be compressed or decompressed in accordance with a compression scheme (e.g., a CSI compression scheme), which may reduce a payload, or a size, or an amount of communications resources involved in the transmission of the CSI report 225. For example, a CSI compression scheme may involve an encoder 240 at the UE 115-b, which may refer to software, firmware, or hardware, or any combination thereof operable to compress a channel (e.g., to compress the CSI report 225 or portion thereof) before transmission in the uplink signaling 220. In some examples, an encoder 240 may be configured in accordance with a codebook (e.g., for a codebook-based CSI compression scheme, for a CSI compression scheme without an auto encoder), which may be signaled or indicated by the base station 105-b. In some examples, an encoder 240 may be configured in accordance with various machine learning techniques (e.g., for a neural network-based CSI compression scheme, when operating as or otherwise in accordance with an auto encoder), where such techniques may be performed by one or both of the base station 105-b or the UE 115-b.

A CSI compression scheme may also involve a decoder 230 at the base station 105-b, which may refer to software, firmware, or hardware, or any combination thereof operable to decompress the channel (e.g., to decompress the CSI report 225 or portion thereof) as received in the uplink signaling 220 by the base station 105-b. In some examples, a decoder 230 may be configured in accordance with a codebook (e.g., for a codebook-based CSI compression scheme, for a CSI compression scheme without an auto decoder), which may be configured or determined at the base station 105-b. In some examples, a decoder 230 may be configured in accordance with various machine learning techniques (e.g., for a neural network-based CSI compression scheme, when operating as or otherwise in accordance with an auto decoder), where such techniques may be performed by one or both of the base station 105-b or the UE 115-b.

Machine learning techniques may be used by the wireless communications system 200 to support CSI compression schemes, which may include training an encoder (e.g., training an auto encoder, evaluating or configuring parameters to be used in the encoder 240), encoding information such as encoding a CSI report 225, training a decoder (e.g., training an auto decoder, evaluating or configuring parameters to be used in the decoder 230), decoding information such as decoding a CSI report 225, or any combination thereof. Such machine learning techniques may include one or more neural networks that may be implemented by one or both of a transmitting device (e.g., the UE 115-b) or a receiving device (e.g., the base station 105-b). Neural networks that may support such machine learning techniques for channel compression include fully connected neural networks, batch normalization neural networks, dropout neural networks, convolutional neural networks, residual neural networks, ReLU neural networks, and other types of neural networks. In some examples, machine learning for channel compression may include or be referred to as a CSI-net or its variations.

Although machine learning techniques may be implemented by the wireless communications system 200 for training CSI compression schemes, in some examples, there may be a mismatch of a channel used for training and a channel used for inference. For example, machine learning techniques may be trained according to a known channel (e.g., lab conditions, known or predicted parameters, known or predicted hardware characteristics, a particular modeling approach), which may not match the devices (e.g., hardware characteristics or configurations of the base station 105-b, of the UE 115-b, or both) or channel statistics (e.g., signal propagation conditions between the base station 105-b and the UE 115-b, signal propagation conditions affecting the downlink signaling 210 or the uplink signaling 220, information or payload associated with a given channel report) for inference, which may be more complicated or may present a risk or uncertainty regarding some machine learning techniques. In some examples, one compression scheme may be unsuitable or otherwise less favorable for conveying the CSI report 225 compared to another compression scheme.

In accordance with one or more aspects of the present disclosure, the wireless communications system 200 may support channel compression according to multiple CSI compression schemes, from which a transmitting device (e.g., the UE 115-b) may select for one or more channel reporting transmissions. For example, the UE 115-b may be configured with multiple CSI compression schemes at least in part by configuration signaling 250, which may be transmitted by the base station 105-b. In various examples, configured or indicated configurations for a respective CSI compression scheme may be associated with an encoder 240 to be used by the UE 115-b for compressing or encoding the CSI report 225, a decoder or decoder configuration used by the UE 115-b for evaluating between CSI compression schemes or associated encoder configurations, a decoder 230 to be used by the base station 105-b for decompressing or decoding the CSI report 225, or any combination thereof.

The configuration signaling 250 may include a first indication 255-a, indicating one or more aspects of a configuration for a first CSI compression scheme. In some examples, a first CSI compression scheme may be a codebook-based CSI compression scheme (e.g., a CSI compression scheme without an auto decoder or an auto encoder), which may refer to a CSI compression scheme that is configured based on a codebook or other set parameters determined or assigned by the base station 105-b, and communicated or otherwise indicated using the first indication 255-a. In some examples, a first CSI compression scheme may be a legacy CSI compression scheme, a CSI compression scheme associated with a legacy decoder, a configuration or codebook associated with Type-I and Type-II CSI, or a compression scheme associated with a first granularity or precision, among other configurations.

The configuration signaling 250 may also include a second indication 255-b, indicating one or more aspects of a configuration for a second CSI compression scheme. In some examples, a second CSI compression scheme may be a neural network-based CSI compression scheme (e.g., a CSI compression scheme with an auto encoder, an auto decoder, or both), which may refer to a CSI compression scheme that is configured or trained based at least in part on a neural network at the UE 115-b, or that is selected or evaluated for selection based at least in part on a neural network at the UE 115-b. In some examples, a second CSI compression scheme may be associated with an auto encoder or an auto decoder having a smaller configuration size, a dynamically configured or semi-persistent CSI compression scheme, a configuration or codebook associated with Type-III CSI, or a compression scheme associated with a second granularity or precision, among other configurations. Each of the different CSI compression schemes may have a different configuration, such as a differently trained or configured encoder, a differently trained or configured decoder, or a combination thereof.

The indications 255 for CSI compression schemes may be provided according to various techniques. For example, the first indication 255-a and the second indication 255-b may be transmitted in a same transmission (e.g., a same transmission burst, a same instance of DCI, common RRC signaling, or other configuration signaling) or in different transmissions (e.g., transmissions separated in time, different instances of DCI, different instances of RRC signaling, or other configuration signaling). In some examples, one or more of the CSI compression schemes indicated by configuration signaling 250 may be updated over time, such that the base station 105-b may transmit, and the UE 115-b may receive, subsequent indications 255 that may revise, replace, add, cancel, or otherwise update CSI compression scheme configurations over time (e.g., based on ongoing machine learning or training of an encoder, or on ongoing machine learning or training of a decoder, or a combination thereof).

To support transmission of a CSI report 225, the UE 115-b may include a CSI compression evaluation component 260 operable to select between first and second CSI compression schemes, or among any other quantity of CSI compression schemes indicated by configuration signaling 250, based on various criteria. In some examples, one of the first or the second CSI compression schemes may be configured (e.g., at the CSI compression evaluation component 260) as a default or target CSI compression scheme (e.g., a neural network-based CSI compression scheme). In some examples, the UE 115-b (e.g., the CSI compression evaluation component 260) may switch to a different CSI compression scheme (e.g., to a codebook-based CSI compression scheme, to a regular codebook, to a legacy codebook, to a fallback CSI compression scheme) or otherwise select a CSI compression scheme if certain conditions are met or not met.

In some examples, a condition for evaluating or selecting between a first CSI compression scheme and a second CSI compression scheme may involve a cross-correlation with or between CSI compression schemes (e.g., a threshold on a cross-correlation with a codebook-based CSI compression scheme). In some examples, a condition for evaluating or selecting between a first CSI compression scheme and a second CSI compression scheme may involve a calculation or comparison of differences or errors associated with different CSI compression schemes (e.g., a threshold or comparison of mean-squared error (MSE) of one CSI compression scheme or another, such as determining to switch to a regular codebook-based CSI compression scheme when a neural network-based CSI compression scheme has a higher MSE). In some examples, an operating condition of the UE 115-b may be considered (e.g., at the CSI compression evaluation component 260) in the evaluation or selection of CSI compression schemes, such as evaluating or selecting a CSI compression scheme based on power availability (e.g., battery status), power consumption (e.g., associated with one CSI compression scheme or another), processor availability (e.g., available processing cycles), processor load (e.g., associated with one CSI compression scheme or another), or any combination thereof.

In an example for evaluating CSI compression schemes relative to power consumption (e.g., associated with performing an encoding in accordance with a particular CSI compression scheme), a codebook-based CSI compression scheme may be associated with a power, P1, and neural network-based CSI compression scheme may be associated with a power, P2. An evaluation between the codebook-based CSI compression scheme and the neural network-based compression scheme by the UE 115-b may be associated with a parameter, α, which may be communicated using configuration signaling 250 (e.g., in an indication 255, in the indication 255-b). If a condition of P1*α<P2 is met, the UE 115-b may select an encoding or decoding in accordance with the codebook-based CSI compression scheme (e.g., configuring the encoder 240 in accordance with the codebook-based CSI compression scheme, encoding the CSI report 225 in accordance with the codebook-based CSI compression scheme, indicating that the decoder 230 should be configured in accordance with the codebook-based CSI compression scheme). If the condition of P1*α<P2 is not met, the UE 115-b may select an encoding or decoding in accordance with the neural network-based CSI compression scheme (e.g., configuring the encoder 240 in accordance with an auto encoder, encoding the CSI report 225 in accordance with the neural network-based compression scheme, indicating that the decoder 230 should be configured in accordance with the neural network-based CSI compression scheme, indicating that the decoder 230 should be configured in accordance with an auto decoder).

Additionally or alternatively, in an example for evaluating CSI compression schemes relative to processing load (e.g., associated with a processing load for performing an encoding in accordance with a particular CSI compression scheme), a codebook-based CSI compression scheme may be associated with a processing load, L1, and neural network-based CSI compression scheme may be associated with a processing load, L2. An evaluation between the codebook-based CSI compression scheme and the neural network-based compression scheme by the UE 115-b may be associated with a parameter, β, which may be communicated using configuration signaling 250 (e.g., in an indication 255, in the indication 255-b). If a condition of L1*β<L2 is met, the UE 115-b may select to perform an encoding in accordance with the codebook-based CSI compression scheme (e.g., configuring the encoder 240 in accordance with the codebook-based CSI compression scheme, encoding the CSI report 225 in accordance with the codebook-based CSI compression scheme, indicating that the decoder 230 should be configured in accordance with the codebook-based CSI compression scheme). If the condition of L1*β<L2 is not met, the UE 115-b may select an encoding or decoding in accordance with the neural network-based CSI compression scheme (e.g., configuring the encoder 240 in accordance with an auto encoder, encoding the CSI report 225 in accordance with the neural network-based compression scheme, indicating that the decoder 230 should be configured in accordance with the neural network-based CSI compression scheme, indicating that the decoder 230 should be configured in accordance with an auto decoder).

In some examples, a condition for selecting one CSI compression scheme or another may be supported by a neural network or corresponding neural network configuration involved in a CSI compression scheme itself (e.g., a neural network associated with the encoder 240, a neural network associated with the decoder 230, or associated with a configuration thereof). For example, a neural network used in the evaluation of CSI compression schemes (e.g., at the CSI compression evaluation component 260) for transmitting a CSI report 225 may take an input of an auto encoder, an estimated channel (e.g., information related to the estimation of signal propagation between the base station 105-b and the UE 115-b), and an output of a regular or default CSI compression scheme (e.g., an output of a neural network-based CSI compression scheme). In some examples, a neural network supporting such an evaluation may output a Boolean value that indicates whether to fall back to the regular or default CSI compression scheme (e.g., fall back to regular CSI, fall back to a codebook-based CSI compression scheme).

In some examples, based on such evaluations of CSI compression schemes, the encoder 240 may be configured to perform an encoding of a CSI report 225 in accordance with a CSI compression scheme selected at the UE 115-b (e.g., by the CSI compression evaluation component 260). Because the selection of a CSI compression scheme at the UE 115-b for transmitting the CSI report 225 may not be otherwise known to the base station 105-b, the UE 115-b may also transmit an indication of one or more aspects of the CSI compression scheme used for compressing the CSI report 225 (e.g., an encoding configuration used at the encoder 240), or an indication of one or more aspects of the CSI compression scheme to be used for decompressing the CSI report 225 (e.g., a decoding configuration to be used at the decoder 230). For example, the UE 115-b may include an indication 270, which may accompany or be otherwise associated with the CSI report 225 (e.g., in the uplink signaling 220), and may indicate an encoder used at the UE 115-b (e.g., a configuration at the encoder 240), or indicate a decoder to be used at the base station 105-b (e.g., a configuration for the decoder 230). The base station 105-b may accordingly configure the decoder 230 for decoding the CSI report 225 based at least in part on the indication 270.

By implementing one or more of the described techniques for channel compression switching, the base station 105-b and the UE 115-b may support implementing channel compression schemes responsive to signal propagation conditions between the base station 105-b and the UE 115-b, or related channel reports or associated information or payloads, or both. Accordingly, compression may be evaluated for relative accuracy or reporting granularity, or ongoing machine learning at the UE 115-b or the base station 105-b, which may change over time or due to changing channel conditions or communications requirements. Moreover, compression schemes may be evaluated in a manner that balances signaling overhead, power consumption, processing load, or various other considerations or combinations of considerations.

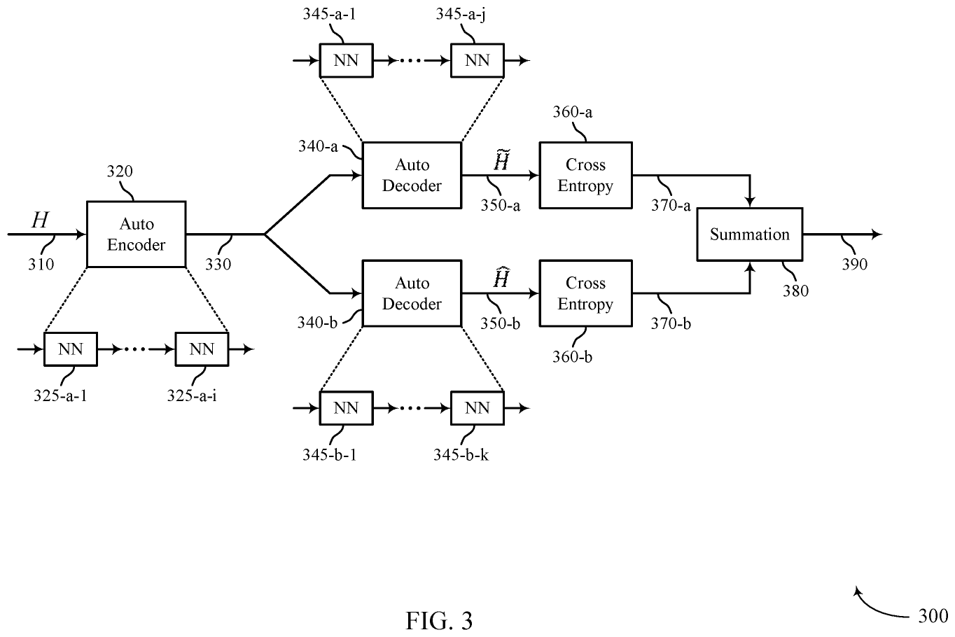

FIG. 3 illustrates an example 300 for joint training of compression schemes that supports techniques for channel state information and channel compression switching in accordance with one or more aspects of the present disclosure. The example 300 may be implemented in joint training or machine learning operations at a base station 105, at a UE 115, or a combination thereof, for adapting one or more CSI compression schemes (e.g., training an encoder, training a decoder, or both).

In the example 300, the joint training may receive, as an input 310, a channel before compression (e.g., a channel, H), which may refer to various forms of channel information associated with a signal propagation path between a transmitting device and a receiving device. The input 310 may be provided to an auto encoder 320, which may be configured according to one or more encoding techniques for compressing an information payload. In some examples, the auto encoder may involve one or more neural networks, such as a chain or sequence of i neural networks 325 (e.g., neural networks 325-a-1 through 325-a-i). In some examples, one or more aspects of a configuration of the auto encoder 320 (e.g., one or more neural networks 325) may be implemented in an encoder 240 of a UE 115 (e.g., for encoding a CSI report 225 or for evaluating a CSI compression scheme). The auto encoder 320 may provide an output 330, which may be referred to as a feedback vector. In some examples, an output 330 or feedback vector may be an example of, or may be otherwise similar to or illustrative of a CSI report 225.

To support one or more aspects of a joint training, the output 330 (e.g., the feedback vector) may be provided to two or more auto decoders 340 (e.g., auto decoder 340-a, associated with a first CSI compression scheme, auto decoder 340-b, associated with a second CSI compression scheme), each of which may be described as being associated with a different branch of a joint training. Each of the auto decoders 340 may be configured according to one or more respective decoding techniques for decompressing an information payload. In some examples, the different auto decoders 340 or associated branches may each output a recovered channel, which may be recovered at different resolution, granularity, precision, or accuracy. In some examples, an auto decoder 340 may involve one or more neural networks, such as a chain or sequence of j neural networks 345 in the auto decoder 340-a (e.g., neural networks 345-a-1 through 345-a-j), or a chain or sequence of k neural networks 345 in the auto decoder 340-b (e.g., neural networks 345-b-1 through 345-b-k). In some examples, one or more aspects of a configuration of an auto decoder 340 (e.g., one or more neural networks 345) may be implemented in an decoder 230 of a base station 105 (e.g., for decoding a CSI report 225), or may be implemented in a CSI compression evaluation component 260 at a UE 115 (e.g., for evaluating CSI compression schemes associated with a CSI report 225).

Different auto decoders 340 may be configured according to various characteristics, which may be leveraged for various aspects of communications or evaluations of CSI compression schemes. In some examples, the auto decoder 340-a (e.g., branch 1) may be associated with a second CSI compression scheme (e.g., a neural network-based CSI compression scheme). In some examples, indication of a configuration of the auto decoder 340-a (e.g., in an indication 255) may be associated with a relatively larger payload, and accordingly may involve relatively larger or less efficient signaling payload, or relatively higher precision. In some examples, the auto decoder 340-a may be associated with a codebook-based CSI compression scheme, and may be an example of a persistent, semi-static, or otherwise less-frequently updated configuration. In some examples, the auto decoder 340-b (e.g., branch 2), or both the auto decoder 340-a and the auto decoder 340-b, may be associated with a CSI compression scheme that is associated with one or more aspects of machine learning, which may be described as a neural network-based CSI compression scheme. In some examples, the auto decoder 340-b may be associated with a Type-III CSI. In some examples, indication of a configuration of the auto decoder 340-b (e.g., in an indication 255) may be associated with a relatively smaller or less complex payload, and accordingly may involve relatively smaller or more efficient signaling payload (e.g., may be simpler to indicate to a UE 115). In some examples, the auto decoder 340-a may be an example of a dynamic or otherwise more-frequently updated configuration.

The different auto decoders 340 may each provide a respective output 350, which may be referred to as decompressed or recovered channel information, or a channel after decompression. In the example 300, the auto decoder 340-a may provide an output 350-a corresponding to a channel after decompression, \tilde{H}, and the auto decoder 340-b may provide an output 350-b corresponding to a channel after decompression, Ĥ. In some examples, the auto decoder 340-a and the auto decoder 340-b may be configured such that Ĥ is associated with a smaller size or reporting payload than \tilde{H}.

Each of the outputs 350 may be provided to a respective cross entropy block 360, which may calculate a respective cross entropy relative to the channel before compression, H. For example, the cross entropy block 360-a may provide an output 370-a corresponding to a cross entropy between H and \tilde{H}, and the cross entropy block 360-b may provide an output 370-a corresponding to a cross entropy between H and Ĥ. In the example 300, the outputs 370-a and 370-b may be provided to a summation block 380, which may provide an output 390 corresponding to an overall training result of the joint training (e.g., for ongoing or periodic training or machine learning).

In some implementations, one or more aspects of the example 300 for joint training of decoders may be configured in a wireless communications system 100 or 200 to support the described techniques for channel compression switching.

In a first set of examples, a base station 105 may configure a UE 115 with an auto encoder (e.g., using an indication 255, to configure an encoder 240 in accordance with one or more aspects of the auto encoder 320) and an auto decoder (e.g., using an indication 255, to configure a CSI compression evaluation component 260 to perform evaluations in accordance with one or more aspects of the auto decoder 340-b), which may support an evaluation by the UE 115 between a first CSI compression scheme associated with the auto decoder 340-a (e.g., a codebook-based CSI compression scheme, a legacy CSI compression scheme, a static or semi-persistent CSI compression scheme, a regular or fallback CSI compression scheme) and a second CSI compression scheme associated with the auto decoder 340-b. In such examples, the base station 105 may train components or associated neural networks including at least the auto encoder 320 and the auto decoder 340-b (e.g., everything from the auto encoder to the auto decoder). In such examples, the UE 115 may not have flexibility to determine its own auto encoder configuration (e.g., for implementation in an encoder 240), but the reduced flexibility may be accompanied by or offset by reduced or simplified signaling, or reduced power consumption or processing load at the UE 115, among other benefits.

In some implementations in accordance with the first set of examples, the UE 115 may indicate a selection of one or both of the first CSI compression scheme or the second CSI compression scheme (e.g., in an indication 270), which may include an indication of whether a CSI report 225 in corresponding uplink signaling 220 should be decoded by the base station 105 in accordance with a configuration of the auto decoder 340-a or a configuration of the auto decoder 340-b, or both. Moreover, in some implementations in accordance with the first set of examples, the base station 105 may also configure (e.g., via configuration signaling 250) criteria (e.g., for the UE 115) to perform an evaluation of or a selection between CSI compression schemes (e.g., for an evaluation by a CSI compression evaluation component 260). Additionally or alternatively, in some implementations in accordance with the first set of examples, the base station 105 may also configure one or more aspects of a neural network-based switching network, or other implementation of a neural network (e.g., one or more neural networks 345) used in the evaluation of or selection between CSI compression schemes.

In a second set of examples, a base station 105 may configure a UE 115 with a first auto decoder (e.g., using an indication 255, to configure a CSI compression evaluation component 260 in accordance with one or more aspects of the auto decoder 340-a), and with a second auto decoder (e.g., using an indication 255, to configure a CSI compression evaluation component 260 to perform evaluations in accordance with one or more aspects of the auto decoder 340-b), which may support an evaluation between a first CSI compression scheme associated with the auto decoder 340-a (e.g., a codebook-based CSI compression scheme, a legacy CSI compression scheme, a static or semi-persistent CSI compression scheme, a regular or fallback CSI compression scheme) and a second CSI compression scheme associated with the auto decoder 340-b. In such examples, the base station 105 may train components including the auto decoder 340-a and the auto decoder 340-b, and the UE 115 may train the auto encoder 320 (e.g., by a CSI compression evaluation component 260, for implementation at an encoder 240) based at least in part on the configuration of the auto decoder 340-a, or the auto decoder 340-b, or both, as received at the UE 115. In other words, in some implementations of the second set of examples, the UE 115 may train or otherwise determine its own auto encoder configuration (e.g., for implementation in an encoder 240), which may support improved flexibility or responsiveness to individual signal propagation conditions, but may be associated with increased power consumption or processing load at the UE 115.

In some implementations in accordance with the second set of examples, the UE 115 may indicate a selection of one or both of the first CSI compression scheme or the second CSI compression scheme (e.g., in an indication 270), which may include an indication of whether a CSI report 225 in corresponding uplink signaling 220 should be decoded by the base station 105 in accordance with a configuration of the auto decoder 340-a or a configuration of the auto decoder 340-b, or both. Moreover, in some implementations in accordance with the second set of examples, the base station 105 may also configure (e.g., via configuration signaling 250) criteria (e.g., for the UE 115) to perform an evaluation of or a selection between CSI compression schemes (e.g., for an evaluation by a CSI compression evaluation component 260). Additionally or alternatively, in some implementations in accordance with the second set of examples, the base station 105 may also configure one or more aspects of a neural network-based switching network, or other implementation of a neural network (e.g., one or more neural networks 345) used in the evaluation of or selection between CSI compression schemes.

In some examples, the described techniques may be implemented such that, instead of using an entire auto decoder to test machine learning-based CSI performance, a smaller network may be introduced to reduce complexity of a complete auto decoder. In some examples, a full network training neural network, or a partial network training neural network may be provided or otherwise supported. Moreover, aspects of the described techniques may be implemented to provide different switching criteria, or particular structures for CSI report configuration, or both.

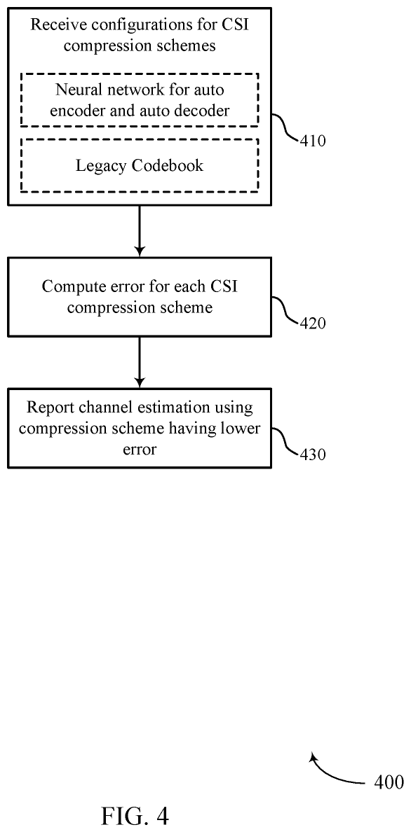

FIG. 4 illustrates an example of a process 400 that supports techniques for channel state information and channel compression switching in accordance with one or more aspects of the present disclosure. The process 400 illustrates an example for evaluating and selecting a CSI compression scheme, which may be performed at a UE 115 (e.g., by a CSI compression evaluation component 260).
At 410, the process 400 may include receiving configurations for CSI compression schemes. In some examples, the configurations may be received from a base station 105, which may involve indications 255 of configuration signaling 250. In some examples, the received configurations may be included in, or otherwise associated with a CSI reporting configuration transmitted by the base station 105, which may include a reference signal configuration and a machine learning CSI configuration. In some examples (e.g., as part of a machine learning CSI configuration), the received configurations may include a configuration associated with an auto encoder 320 or a first auto decoder (e.g., an auto decoder 340-a), a configuration associated with a second auto decoder (e.g., an auto decoder 340-b), and a regular CSI codebook (e.g., a configuration associated with a codebook-based CSI compression scheme). In some examples, the received configuration may refer to a neural network configuration that includes a configuration for an auto encoder and an auto decoder. In some examples, the received configuration may refer to a neural network configuration that includes a configuration for a first auto decoder and a second auto decoder. Some examples may include a configuration of a neural network operable to support an evaluation of CSI compression schemes (e.g., a configuration of a neural network 345).

In some examples, a UE 115 may receive a configuration of a neural network for an auto encoder (e.g., of a neural network 325), for an auto decoder (e.g., of a neural network 345), or a combination thereof, which may be an example of a configuration of a neural network-based CSI compression scheme. Additionally or alternatively, a UE 115 may receive a legacy codebook or other codebook or configuration, which may be associated with a configuration of a codebook-based CSI compression scheme (e.g., with a codebook-configured encoder, with a codebook-configured decoder, without an auto encoder, or without an auto decoder). In other examples of the process 400, different configurations may be provided for a neural network-based CSI compression scheme and a codebook-based CSI compression scheme, among other types of different CSI compression schemes that may be indicated to the UE 115.
At 420, the process 400 may include computing an error for each of the CSI compression schemes for which a configuration was received at 410. For example, the UE 115 may use a configured auto encoder and decoder for channel compression, and check an error of an output channel. In some examples, the error may correspond to an error (e.g., an MSE) or other difference between a channel after decompression (e.g., Ñ, Ĥ) and a channel before compression (e.g., H, a reference channel). In some examples, a UE 115 may be configured with a legacy codebook, and use the legacy codebook for CSI calculation and compute the MSE versus an ideal channel.
At 430, the process may include reporting channel estimation using a compression scheme having a lower error. For example, if an error (e.g., MSE) of a neural network-based CSI compression is less than an error of a codebook-based CSI compression, the UE 115 may report a neural network-based compression (e.g., compressing or encoding a CSI report in accordance with a neural network-based encoder or auto encoder, indicating that the UE 115 selected a neural network-based compression, indicating, in an indication 255, that a channel report has been encoded or compressed or should be decoded or decompressed in accordance with a neural network-based CSI compression scheme). In another example, if an error (e.g., MSE) of a neural network-based CSI compression is greater than an error of a codebook-based CSI compression, the UE 115 may report a configured codebook-based compression (e.g., compressing or encoding a CSI report in accordance with a codebook-based encoder, indicating that the UE 115 selected a codebook-based compression, indicating, in an indication 255, that a channel report has been encoded or compressed or should be decoded or decompressed in accordance with a codebook-based CSI compression scheme). In some examples, if the MSE of the output channel is worse than a codebook-based compression, the UE 115 may be configured to switch the configured codebook. In some examples, the UE 115 may signal a preferred or new codebook.

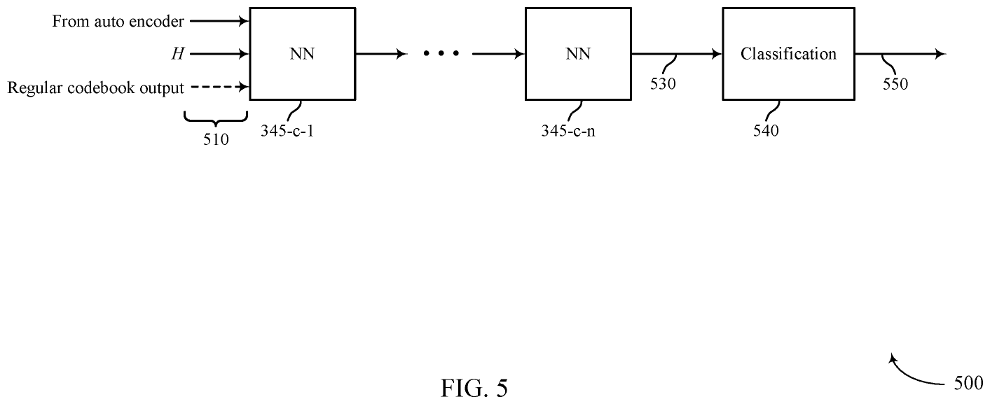

FIG. 5 illustrates an example 500 of a neural network-based switching that supports techniques for channel state information and channel compression switching in accordance with one or more aspects of the present disclosure. The example 500 may illustrate techniques for switching or selecting CSI compression schemes, and may be performed or implemented in a UE 115.

In the example 500, a set or sequence of one or more neural networks 345-c may be combined to support an evaluation of CSI compression schemes. In some examples, the one or more neural networks 345 may be equivalent to, or may be included in, an auto decoder 340. In some examples, to support performing the evaluation in accordance with the example 500 (e.g., at a UE 115), the one or more neural networks 345-c may be configured in a manner that equivalent or otherwise corresponding neural networks at a decoder 230 of a base station 105 are configured.

In the example 500, a set of inputs 510 may be provided to the neural networks 345-c. For example, the set of inputs 510 may include an output from an auto encoder (e.g., results or output from an auto encoder 320), such as Type-I or Type-II CSI output, which may be an example of or otherwise correspond to a feedback vector (e.g., an output 330). In some examples, the set of inputs 510 may include a channel before compression, H, which may be an example of or otherwise correspond to an input 310. Additionally or alternatively, the set of inputs 510 may include a precoder before compression (e.g., a precoder, W). In some examples, the set of inputs 510 may include a regular codebook output (e.g., an output 350 associated with a codebook-based CSI compression, a channel after decompression, \tilde{H}).

The set or sequence of neural networks 345-c may perform various operations based on the set of inputs 510, and provide an output 530 to a classification block 540. In some examples, the output 530 may be an example of another channel after decompression (e.g., another output 350, a channel after decompression, A). The classification block 540 may include various evaluation criteria, such as criteria for comparing results of one CSI compression scheme to results of another. In some examples, one or more criteria of the classification block 540, or one or more aspects of a configuration of a neural network 345-c, or both, may be configured by a base station 105 (e.g., using configuration signaling 250).

In some examples, the classification block 540 may provide an output 550, which may be associated with a selection or determination to implement one CSI compression scheme or another. In one example, the output 550 may be a binary output, such as a value of ‘0’ corresponding to using a regular CSI compression scheme and a value of ‘1’ corresponding to using a machine learning CSI compression scheme (e.g., a CSI compression scheme that leverages machine learning, including for periodic or otherwise ongoing training or updates to an encoder, a decoder, or both).

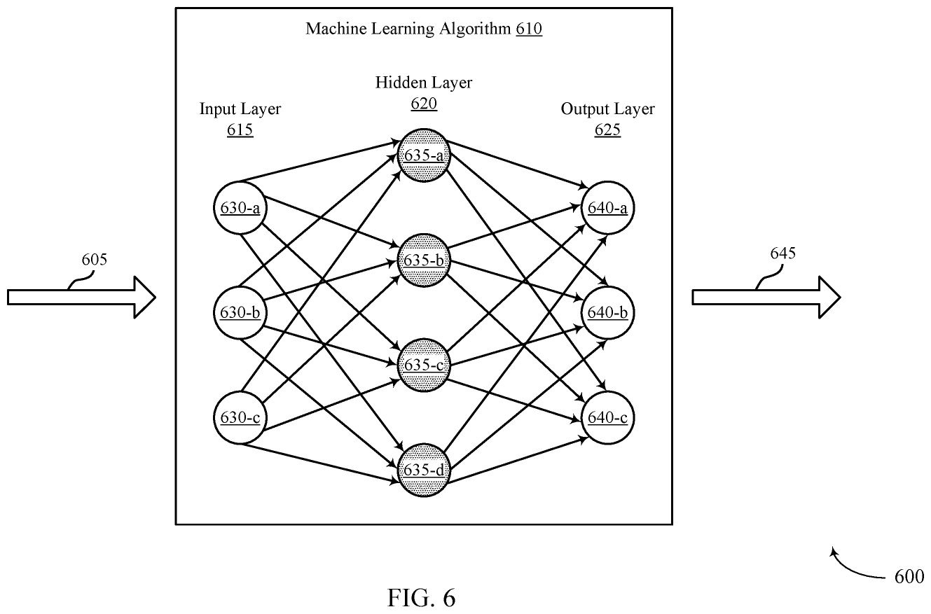

FIG. 6 illustrates an example of a machine learning process 600 that supports techniques for channel state information and channel compression switching in accordance with one or more aspects of the present disclosure. The machine learning process 600 may be implemented at a base station 105, or a UE 115, or both as described with reference to FIGS. 1 through 5.

The machine learning process 600 may include a machine learning algorithm 610. As illustrated, the machine learning algorithm 610 may be an example of a neural network, such as a feed forward (FF) or deep feed forward (DFF) neural network, a recurrent neural network (RNN), a long/short term memory (LSTM) neural network, or any other type of neural network. However, any other machine learning algorithms may be supported. For example, the machine learning algorithm 610 may implement a nearest neighbor algorithm, a linear regression algorithm, a Naïve Bayes algorithm, a random forest algorithm, or any other machine learning algorithm. Furthermore, the machine learning process 600 may involve supervised learning, unsupervised learning, semi-supervised learning, reinforcement learning, or any combination thereof.

The machine learning algorithm 610 may include an input layer 615, one or more hidden layers 620, and an output layer 625. In a fully connected neural network with one hidden layer 620, each hidden layer node 635 may receive a value from each input layer node 630 as input, where each input may be weighted. These neural network weights may be based on a cost function that is revised during training of the machine learning algorithm 610. Similarly, each output layer node 640 may receive a value from each hidden layer node 635 as input, where the inputs are weighted. If post-deployment training (e.g., online training) is supported, memory may be allocated to store errors and/or gradients for reverse matrix multiplication. These errors and/or gradients may support updating the machine learning algorithm 610 based on output feedback. Training the machine learning algorithm 610 may support computation of the weights (e.g., connecting the input layer nodes 630 to the hidden layer nodes 635 and the hidden layer nodes 635 to the output layer nodes 640) to map an input pattern to a desired output outcome. This training may result in a device-specific machine learning algorithm 610 based on the historic application data and data transfer for a specific base station 105 or UE 115.

In some examples, input values 605 may be sent to the machine learning algorithm 610 for processing. In some example, preprocessing may be performed according to a sequence of operations on the input values 605 such that the input values 605 may be in a format that is compatible with the machine learning algorithm 610. The input values 605 may be converted into a set of k input layer nodes 630 at the input layer 615. In some cases, different measurements may be input at different input layer nodes 630 of the input layer 615. Some input layer nodes 630 may be assigned default values (e.g., values of 0) if the number of input layer nodes 630 exceeds the number of inputs corresponding to the input values 605. As illustrated, the input layer 615 may include three input layer nodes 630-a, 630-b, and 630-c. However, it is to be understood that the input layer 615 may include any number of input layer nodes 630 (e.g., 20 input nodes).

The machine learning algorithm 610 may convert the input layer 615 to a hidden layer 620 based on a number of input-to-hidden weights between the k input layer nodes 630 and the n hidden layer nodes 635. The machine learning algorithm 610 may include any number of hidden layers 620 as intermediate steps between the input layer 615 and the output layer 625. Additionally, each hidden layer 620 may include any number of nodes. For example, as illustrated, the hidden layer 620 may include four hidden layer nodes 635-a, 635-b, 635-c, and 635-d. However, it is to be understood that the hidden layer 620 may include any number of hidden layer nodes 635 (e.g., 10 input nodes). In a fully connected neural network, each node in a layer may be based on each node in the previous layer. For example, the value of hidden layer node 635-a may be based on the values of input layer nodes 630-a, 630-b, and 630-c (e.g., with different weights applied to each node value).

The machine learning algorithm 610 may determine values for the output layer nodes 640 of the output layer 625 following one or more hidden layers 620. For example, the machine learning algorithm 610 may convert the hidden layer 620 to the output layer 625 based on a number of hidden-to-output weights between the n hidden layer nodes 635 and the m output layer nodes 640. In some cases, n=m. Each output layer node 640 may correspond to a different output value 645 of the machine learning algorithm 610. As illustrated, the machine learning algorithm 610 may include three output layer nodes 640-a, 640-b, and 640-c, supporting three different threshold values. However, it is to be understood that the output layer 625 may include any number of output layer nodes 640. In some examples, post-processing may be performed on the output values 645 according to a sequence of operations such that the output values 645 may be in a format that is compatible with reporting the output values 645.

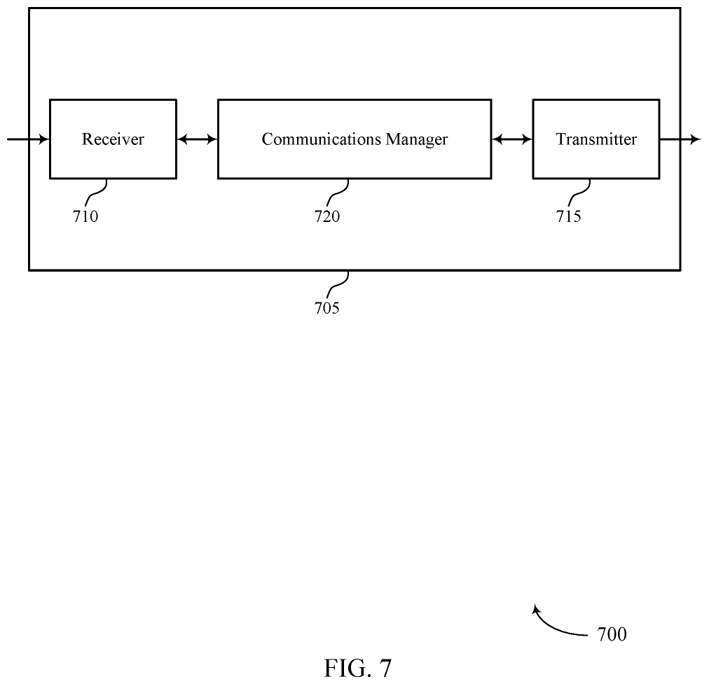

FIG. 7 shows a block diagram 700 of a device 705 that supports techniques for channel state information and channel compression switching in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for channel state information and channel compression switching). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for channel state information and channel compression switching). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for channel state information and channel compression switching as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. For example, the communications manager 720 may be configured as or otherwise support a means for receiving first signaling indicating a first configuration associated with a first channel state information compression scheme (e.g., a codebook-based channel state information compression scheme) and a second configuration associated with a second channel state information compression scheme (e.g., a neural network-based channel state information compression scheme). The communications manager 720 may be configured as or otherwise support a means for transmitting, based on receiving the first signaling, second signaling including channel information estimated by the UE and an indication that the channel information is compressed or is to be decompressed in accordance with the first channel state information compression scheme, or in accordance with the second channel state information compression scheme, or both.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for implementing channel compression schemes responsive to signal propagation conditions between the device 705 and a base station 105, or related channel reports or associated information or payloads, or both. Accordingly, compression may be evaluated for relative accuracy or reporting granularity, or ongoing machine learning at the device 705 or the base station 105, which may change over time or due to changing channel conditions or communications requirements. Moreover, compression schemes may be evaluated by the device 705 in a manner that balances signaling overhead, power consumption, processing load, or various other considerations or combinations of considerations.

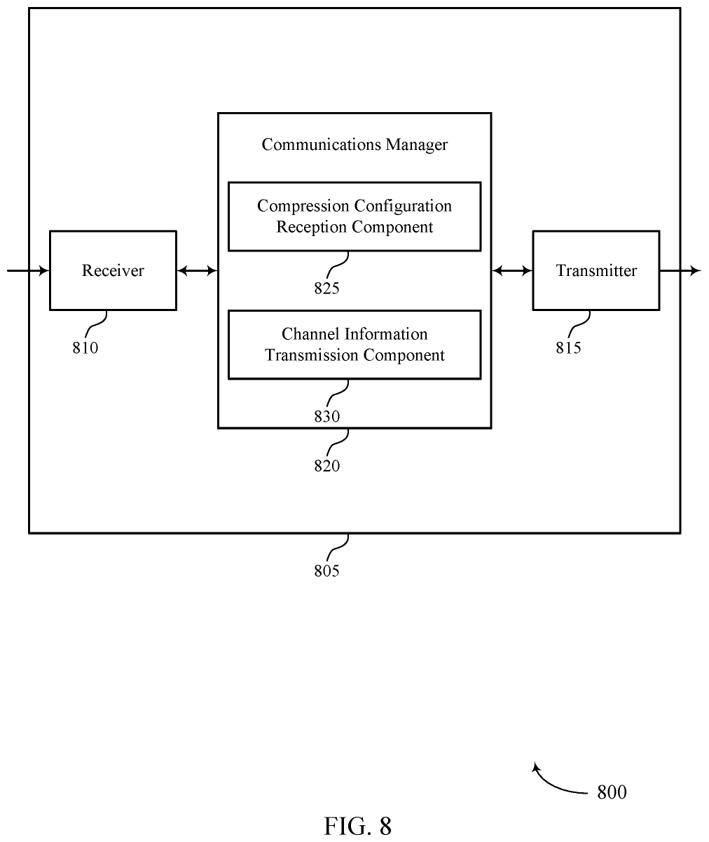

FIG. 8 shows a block diagram 800 of a device 805 that supports techniques for channel state information and channel compression switching in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for channel state information and channel compression switching). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for channel state information and channel compression switching). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for channel state information and channel compression switching as described herein. For example, the communications manager 820 may include a compression configuration reception component 825 a channel information transmission component 830, or both. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. The compression configuration reception component 825 may be configured as or otherwise support a means for receiving first signaling indicating a first configuration associated with a codebook-based channel state information compression scheme and a second configuration associated with a neural network-based channel state information compression scheme. The channel information transmission component 830 may be configured as or otherwise support a means for transmitting, based on receiving the first signaling, second signaling including channel information estimated by the UE and an indication that the channel information is compressed or is to be decompressed in accordance with the codebook-based channel state information compression scheme, or in accordance with the neural network-based channel state information compression scheme, or both.

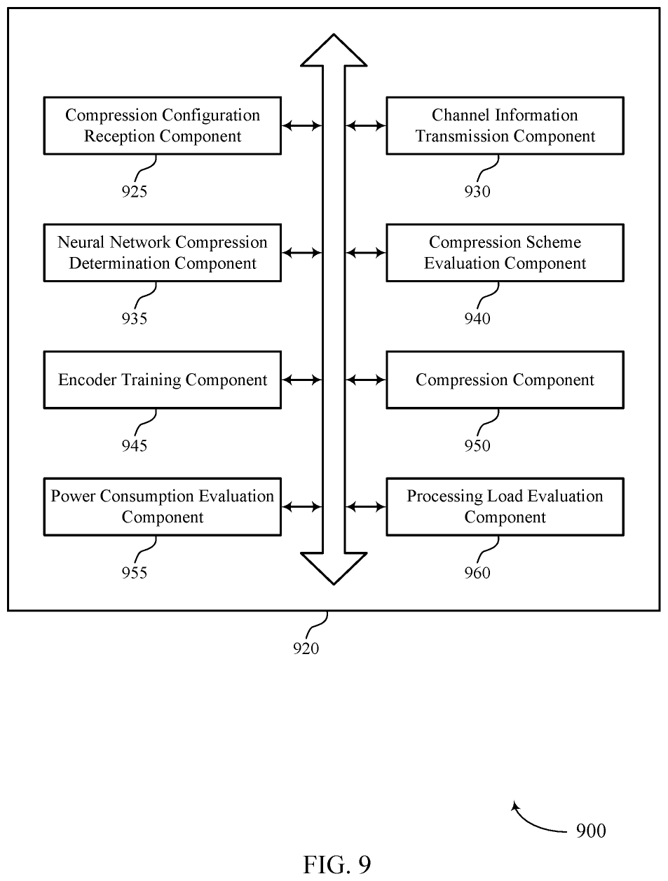

FIG. 9 shows a block diagram 900 of a communications manager 920 that supports techniques for channel state information and channel compression switching in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for channel state information and channel compression switching as described herein. For example, the communications manager 920 may include a compression configuration reception component 925, a channel information transmission component 930, a neural network compression determination component 935, a compression scheme evaluation component 940, an encoder training component 945, a compression component 950, a power consumption evaluation component 955, a processing load evaluation component 960, or any combination thereof. Each of these components may communicate, directly or indirectly, with one another (e.g., via one or more buses).

The communications manager 920 may support wireless communication at a UE in accordance with examples as disclosed herein. The compression configuration reception component 925 may be configured as or otherwise support a means for receiving first signaling indicating a first configuration associated with a codebook-based channel state information compression scheme and a second configuration associated with a neural network-based channel state information compression scheme. The channel information transmission component 930 may be configured as or otherwise support a means for transmitting, based on receiving the first signaling, second signaling including channel information estimated by the UE and an indication that the channel information is compressed or is to be decompressed in accordance with the codebook-based channel state information compression scheme, or in accordance with the neural network-based channel state information compression scheme, or both.

In some examples, the neural network compression determination component 935 may be configured as or otherwise support a means for determining, using a neural network associated with the neural network-based channel state information compression scheme and based on the channel information, whether to compress the channel information in accordance with the codebook-based channel state information compression scheme, or in accordance with the neural network-based channel state information compression scheme, or both. In some examples, the first signaling may include a configuration of the neural network for determining whether to compress the channel information in accordance with the codebook-based channel state information compression scheme, or in accordance with the neural network-based channel state information compression scheme, or both.

In some examples, the compression scheme evaluation component 940 may be configured as or otherwise support a means for determining a first mean squared error associated with a compression in accordance with the codebook-based channel state information compression scheme. In some examples, the compression scheme evaluation component 940 may be configured as or otherwise support a means for determining a second mean squared error associated with a compression in accordance with the neural network-based channel state information compression scheme. In some examples, the compression scheme evaluation component 940 may be configured as or otherwise support a means for determining, based on a comparison between the first mean squared error and the second mean squared error, whether to compress the channel information in accordance with the codebook-based channel state information compression scheme, or in accordance with the neural network-based channel state information compression scheme, or both.

In some examples, the compression scheme evaluation component 940 may be configured as or otherwise support a means for determining a first compression of the channel information based on the codebook-based channel state information compression scheme. In some examples, the compression scheme evaluation component 940 may be configured as or otherwise support a means for determining a second compression of the channel information based on the neural network-based channel state information compression scheme. In some examples, the compression scheme evaluation component 940 may be configured as or otherwise support a means for determining, based on a cross-correlation between the first compression and the second compression, whether to compress the channel information in accordance with the codebook-based channel state information compression scheme, or in accordance with the neural network-based channel state information compression scheme, or both.

In some example, the first signaling may indicate a criteria for determining (e.g., for the UE to determine) whether to compress the channel information in accordance with the codebook-based channel state information compression scheme, or in accordance with the neural network-based channel state information compression scheme, or both.

In some examples, the encoder training component 945 may be configured as or otherwise support a means for training an encoder based on a first decoder indicated by the first configuration, or on a second decoder indicated by the second configuration, or both. In some examples, the compression component 950 may be configured as or otherwise support a means for compressing the channel information based on the trained encoder.

In some examples, the power consumption evaluation component 955 may be configured as or otherwise support a means for determining, based on a power consumption associated with the codebook-based channel state information compression scheme, or a power consumption associated with the neural network-based channel state information compression scheme, or both, whether to compress the channel information in accordance with the codebook-based channel state information compression scheme, or in accordance with the neural network-based channel state information compression scheme, or both.

In some examples, the processing load evaluation component 960 may be configured as or otherwise support a means for determining, based on a processing load associated with the codebook-based channel state information compression scheme, or a processing load associated with the neural network-based channel state information compression scheme, or both, whether to compress the channel information in accordance with the codebook-based channel state information compression scheme, or in accordance with the neural network-based channel state information compression scheme, or both.

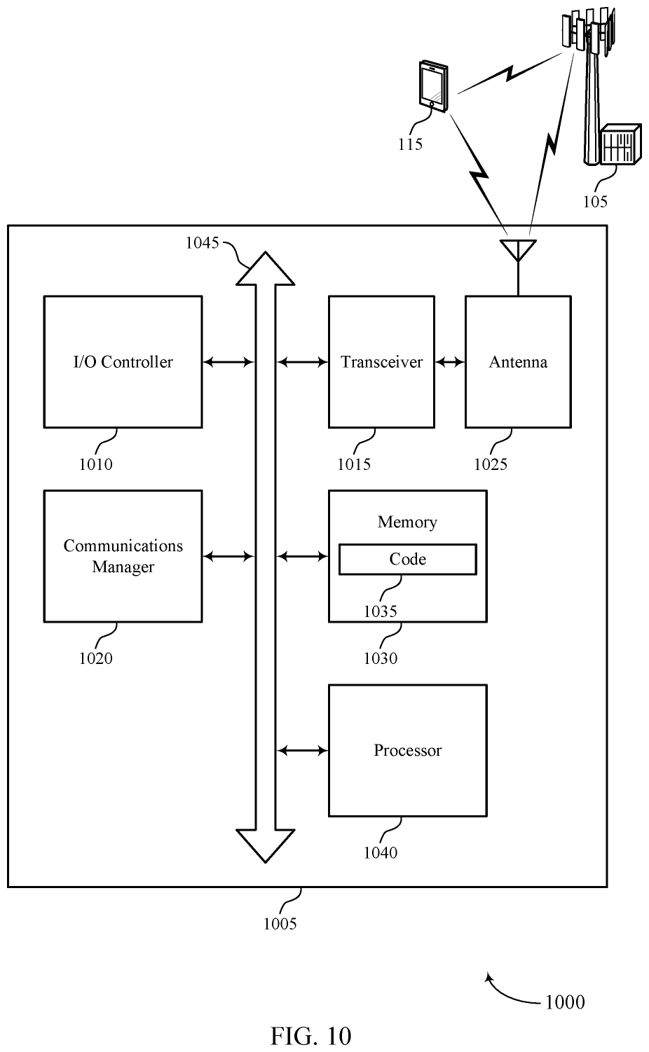

FIG. 10 shows a diagram of a system 1000 including a device 1005 that supports techniques for channel state information and channel compression switching in accordance with one or more aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for channel state information and channel compression switching). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving first signaling indicating a first configuration associated with a first channel state information compression scheme (e.g., a codebook-based channel state information compression scheme) and a second configuration associated with a second channel state information compression scheme (e.g., a neural network-based channel state information compression scheme). The communications manager 1020 may be configured as or otherwise support a means for transmitting, based on receiving the first signaling, second signaling including channel information estimated by the UE and an indication that the channel information is compressed or is to be decompressed in accordance with the first channel state information compression scheme, or in accordance with the second channel state information compression scheme, or both.

By including or configuring the communications manager 1020 in accordance with examples as described herein, the device 1005 may support techniques for implementing channel compression schemes responsive to signal propagation conditions between the device 1005 and a base station 105, or related channel reports or associated information or payloads, or both. Accordingly, compression may be evaluated for relative accuracy or reporting granularity, or ongoing machine learning at the device 1005 or the base station 105, which may change over time or due to changing channel conditions or communications requirements. Moreover, compression schemes may be evaluated by the device 1005 in a manner that balances signaling overhead, power consumption, processing load, or various other considerations or combinations of considerations.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for channel state information and channel compression switching as described herein, or the processor 1040 and the memory 1030 may be otherwise configured to perform or support such operations.

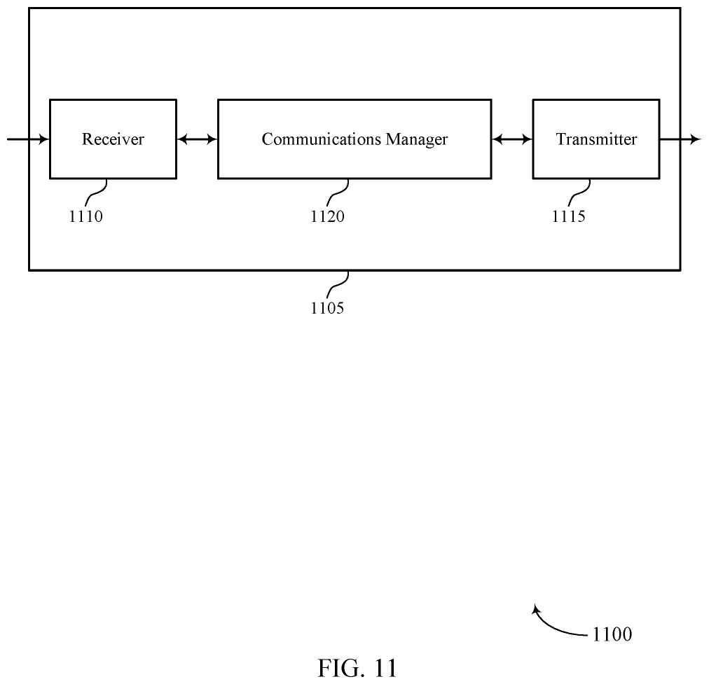

FIG. 11 shows a block diagram 1100 of a device 1105 that supports techniques for channel state information and channel compression switching in accordance with one or more aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for channel state information and channel compression switching). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for channel state information and channel compression switching). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of techniques for channel state information and channel compression switching as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. For example, the communications manager 1120 may be configured as or otherwise support a means for transmitting first signaling indicating a first configuration associated with a first channel state information compression scheme (e.g., a codebook-based channel state information compression scheme) and a second configuration associated with a second channel state information compression scheme (e.g., a neural network-based channel state information compression scheme). The communications manager 1120 may be configured as or otherwise support a means for receiving, based on transmitting the first signaling, second signaling including channel information estimated by the UE and an indication that the channel information is compressed or is to be decompressed in accordance with the first channel state information compression scheme, or in accordance with the second channel state information compression scheme, or both.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for implementing channel compression schemes responsive to signal propagation conditions between the device 1105 and a UE 115, or related channel reports or associated information or payloads, or both. Accordingly, compression may be evaluated by a UE 115 for relative accuracy or reporting granularity, or ongoing machine learning at the UE 115 or the device 1105, which may change over time or due to changing channel conditions or communications requirements. Moreover, compression schemes may be evaluated by the UE 115 in a manner that balances signaling overhead, power consumption, processing load, or various other considerations or combinations of considerations.

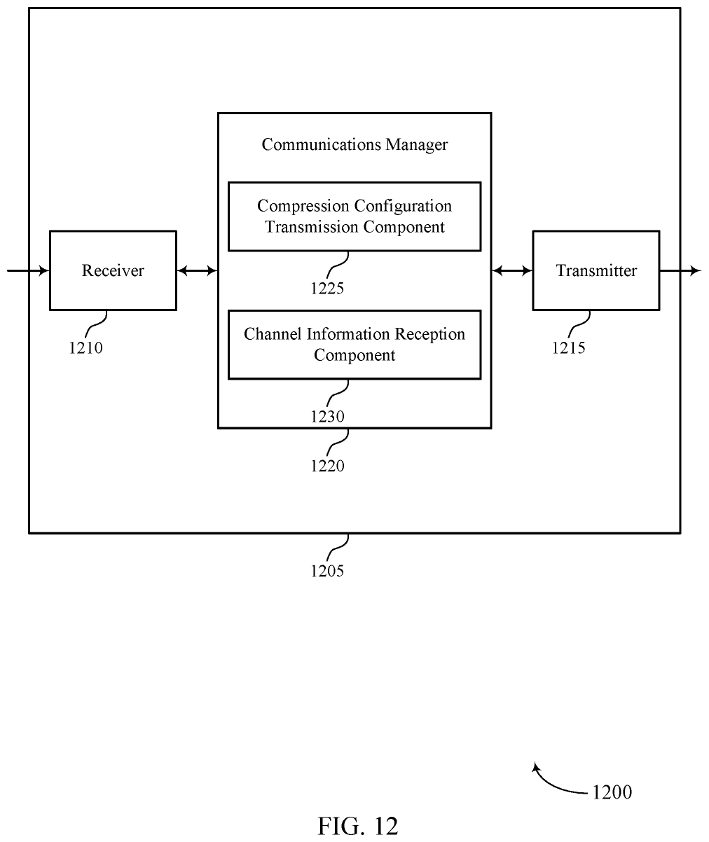

FIG. 12 shows a block diagram 1200 of a device 1205 that supports techniques for channel state information and channel compression switching in accordance with one or more aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for channel state information and channel compression switching). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for channel state information and channel compression switching). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for channel state information and channel compression switching as described herein. For example, the communications manager 1220 may include a compression configuration transmission component 1225 a channel information reception component 1230, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. The compression configuration transmission component 1225 may be configured as or otherwise support a means for transmitting first signaling indicating a first configuration associated with a codebook-based channel state information compression scheme and a second configuration associated with a neural network-based channel state information compression scheme. The channel information reception component 1230 may be configured as or otherwise support a means for receiving, based on transmitting the first signaling, second signaling including channel information estimated by the UE and an indication that the channel information is compressed or is to be decompressed in accordance with the codebook-based channel state information compression scheme, or in accordance with the neural network-based channel state information compression scheme, or both.

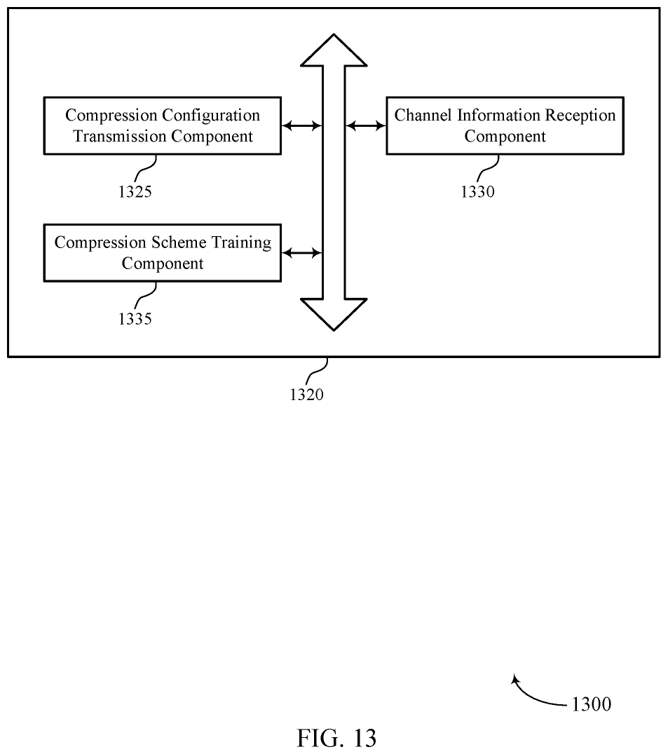

FIG. 13 shows a block diagram 1300 of a communications manager 1320 that supports techniques for channel state information and channel compression switching in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for channel state information and channel compression switching as described herein. For example, the communications manager 1320 may include a compression configuration transmission component 1325, a channel information reception component 1330, a compression scheme training component 1335, or any combination thereof. Each of these components may communicate, directly or indirectly, with one another (e.g., via one or more buses).

The communications manager 1320 may support wireless communication at a base station in accordance with examples as disclosed herein. The compression configuration transmission component 1325 may be configured as or otherwise support a means for transmitting first signaling indicating a first configuration associated with a codebook-based channel state information compression scheme and a second configuration associated with a neural network-based channel state information compression scheme. The channel information reception component 1330 may be configured as or otherwise support a means for receiving, based on transmitting the first signaling, second signaling including channel information estimated by the UE and an indication that the channel information is compressed or is to be decompressed in accordance with the codebook-based channel state information compression scheme, or in accordance with the neural network-based channel state information compression scheme, or both.

In some examples, the first signaling may indicate a criteria for determining (e.g., for the UE to determine) whether to compress the channel information in accordance with the codebook-based channel state information compression scheme, or in accordance with the neural network-based channel state information compression scheme, or both

In some examples, the first signaling may include a configuration of a neural network at the UE for determining whether to compress the channel information in accordance with the codebook-based channel state information compression scheme, or in accordance with the neural network-based channel state information compression scheme, or both

In some examples, the neural network-based channel state information compression scheme may be associated with a smaller payload than the codebook-based channel state information compression scheme, or a greater degree of compression than the codebook-based channel state information compression scheme, or both

In some examples, the compression scheme training component 1335 may be configured as or otherwise support a means for training an encoder and a decoder associated with the neural network-based channel state information compression scheme, the first signaling indicating a configuration of the trained encoder and a configuration of the trained decoder.

In some examples, the compression scheme training component 1335 may be configured as or otherwise support a means for training a first decoder associated with the codebook-based channel state information compression scheme and a second decoder associated with the neural network-based channel state information compression scheme, the first signaling indicating a configuration of the trained first decoder and a configuration of the trained second decoder.

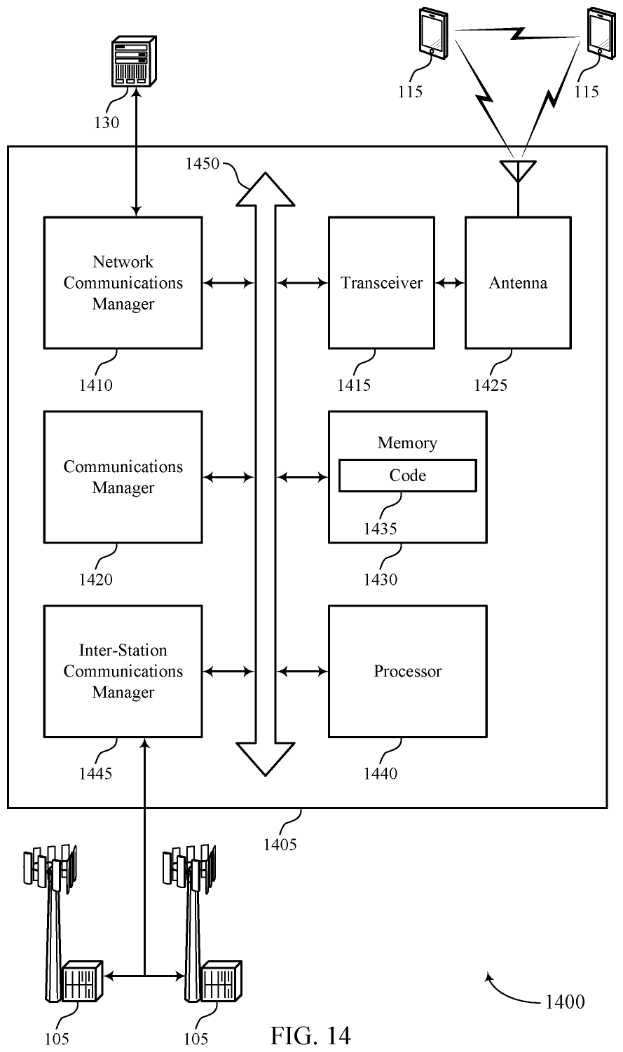

FIG. 14 shows a diagram of a system 1400 including a device 1405 that supports techniques for channel state information and channel compression switching in accordance with one or more aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting techniques for channel state information and channel compression switching). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a base station in accordance with examples as disclosed herein. For example, the communications manager 1420 may be configured as or otherwise support a means for transmitting first signaling indicating a first configuration associated with first channel state information compression scheme (e.g., a codebook-based channel state information compression scheme) and a second configuration associated with a second channel state information compression scheme (e.g., a neural network-based channel state information compression scheme). The communications manager 1420 may be configured as or otherwise support a means for receiving, based on transmitting the first signaling, second signaling including channel information estimated by the UE and an indication that the channel information is compressed or is to be decompressed in accordance with the first channel state information compression scheme, or in accordance with the second channel state information compression scheme, or both.

By including or configuring the communications manager 1420 in accordance with examples as described herein, the device 1405 may support techniques for implementing channel compression schemes responsive to signal propagation conditions between the device 1405 and a UE 115, or related channel reports or associated information or payloads, or both. Accordingly, compression may be evaluated by a UE 115 for relative accuracy or reporting granularity, or ongoing machine learning at the UE 115 or the device 1405, which may change over time or due to changing channel conditions or communications requirements. Moreover, compression schemes may be evaluated by the UE 115 in a manner that balances signaling overhead, power consumption, processing load, or various other considerations or combinations of considerations.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of techniques for channel state information and channel compression switching as described herein, or the processor 1440 and the memory 1430 may be otherwise configured to perform or support such operations.

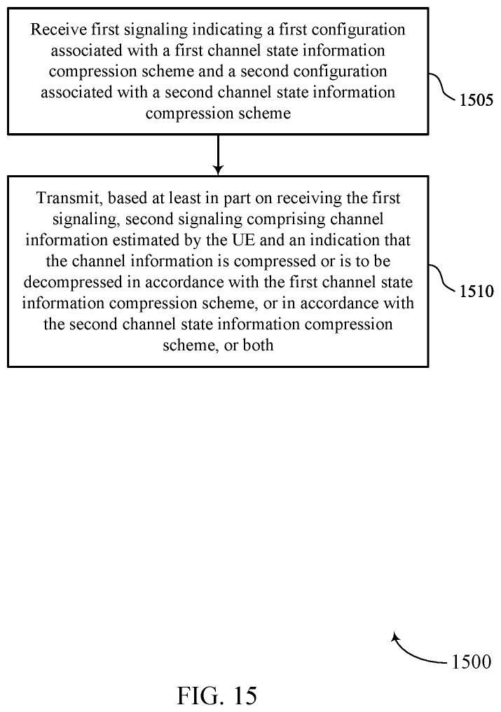

FIG. 15 shows a flowchart illustrating a method 1500 that supports techniques for channel state information and channel compression switching in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.
At 1505, the method may include receiving first signaling indicating a first configuration associated with a first channel state information compression scheme and a second configuration associated with a second channel state information compression scheme. In some examples, the first channel state information compression scheme may be a codebook-based channel state information compression scheme, and the second channel state information compression scheme may be a neural network-based channel state information compression scheme. The operations of 1505 may be performed in accordance with examples as disclosed herein. In some examples, aspects of the operations of 1505 may be performed by a compression configuration reception component 925 as described with reference to FIG. 9.
At 1510, the method may include transmitting, based on receiving the first signaling, second signaling including channel information estimated by the UE and an indication that the channel information is compressed or is to be decompressed in accordance with the codebook-based channel state information compression scheme, or in accordance with the neural network-based channel state information compression scheme, or both. The operations of 1510 may be performed in accordance with examples as disclosed herein. In some examples, aspects of the operations of 1510 may be performed by a channel information transmission component 930 as described with reference to FIG. 9.

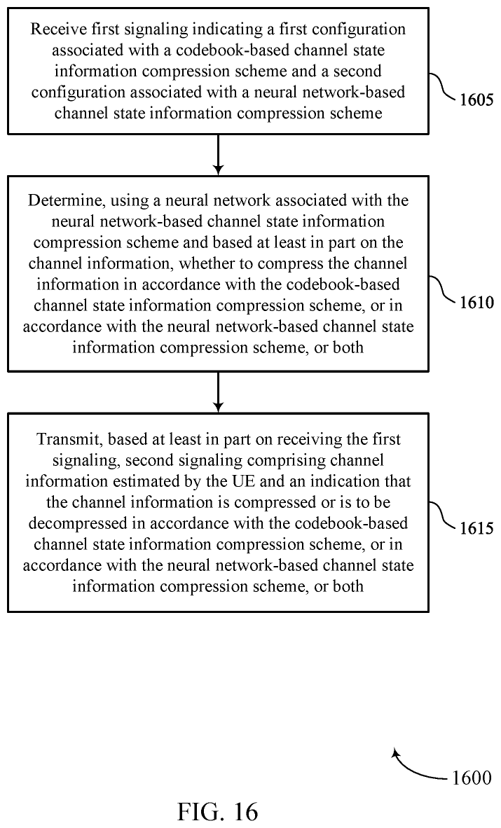

FIG. 16 shows a flowchart illustrating a method 1600 that supports techniques for channel state information and channel compression switching in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.
At 1605, the method may include receiving first signaling indicating a first configuration associated with a codebook-based channel state information compression scheme and a second configuration associated with a neural network-based channel state information compression scheme. The operations of 1605 may be performed in accordance with examples as disclosed herein. In some examples, aspects of the operations of 1605 may be performed by a compression configuration reception component 925 as described with reference to FIG. 9.
At 1610, the method may include determining, using a neural network associated with the neural network-based channel state information compression scheme and based on the channel information, whether to compress the channel information in accordance with the codebook-based channel state information compression scheme, or in accordance with the neural network-based channel state information compression scheme, or both. The operations of 1610 may be performed in accordance with examples as disclosed herein. In some examples, aspects of the operations of 1610 may be performed by a neural network compression determination component 935 as described with reference to FIG. 9.
At 1615, the method may include transmitting, based on receiving the first signaling, second signaling including channel information estimated by the UE and an indication that the channel information is compressed or is to be decompressed in accordance with the codebook-based channel state information compression scheme, or in accordance with the neural network-based channel state information compression scheme, or both (e.g., based at least in part on the determination of 1610). The operations of 1615 may be performed in accordance with examples as disclosed herein. In some examples, aspects of the operations of 1615 may be performed by a channel information transmission component 930 as described with reference to FIG. 9.

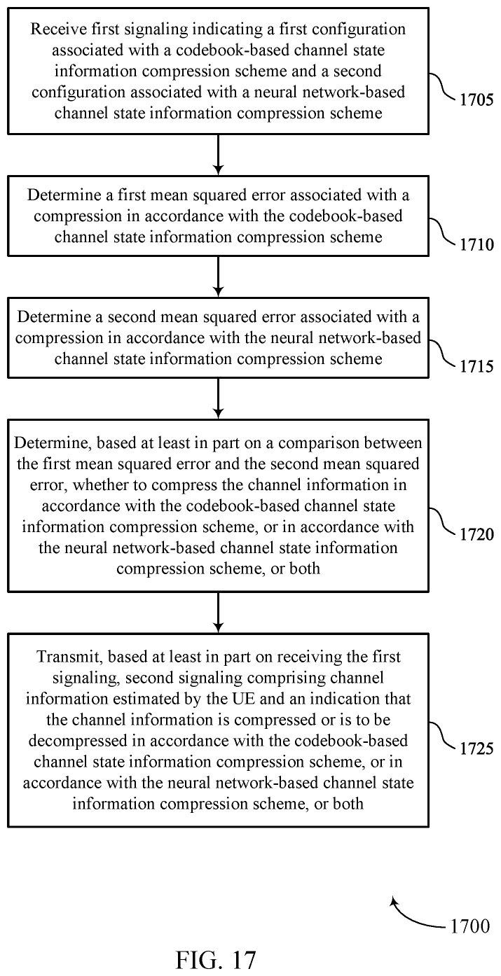

FIG. 17 shows a flowchart illustrating a method 1700 that supports techniques for channel state information and channel compression switching in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.
At 1705, the method may include receiving first signaling indicating a first configuration associated with a codebook-based channel state information compression scheme and a second configuration associated with a neural network-based channel state information compression scheme. The operations of 1705 may be performed in accordance with examples as disclosed herein. In some examples, aspects of the operations of 1705 may be performed by a compression configuration reception component 925 as described with reference to FIG. 9.
At 1710, the method may include determining a first mean squared error associated with a compression (e.g., of channel information estimated by the UE) in accordance with the codebook-based channel state information compression scheme. The operations of 1710 may be performed in accordance with examples as disclosed herein. In some examples, aspects of the operations of 1710 may be performed by a compression scheme evaluation component 940 as described with reference to FIG. 9.
At 1715, the method may include determining a second mean squared error associated with a compression (e.g., of the channel information estimated by the UE) in accordance with the neural network-based channel state information compression scheme. The operations of 1715 may be performed in accordance with examples as disclosed herein. In some examples, aspects of the operations of 1715 may be performed by a compression scheme evaluation component 940 as described with reference to FIG. 9.
At 1720, the method may include determining, based on a comparison between the first mean squared error and the second mean squared error, whether to compress the channel information in accordance with the codebook-based channel state information compression scheme, or in accordance with the neural network-based channel state information compression scheme, or both. The operations of 1720 may be performed in accordance with examples as disclosed herein. In some examples, aspects of the operations of 1720 may be performed by a compression scheme evaluation component 940 as described with reference to FIG. 9.
At 1725, the method may include transmitting, based on receiving the first signaling, second signaling including channel information estimated by the UE and an indication that the channel information is compressed or is to be decompressed in accordance with the codebook-based channel state information compression scheme, or in accordance with the neural network-based channel state information compression scheme, or both (e.g., based at least in part on the determination of 1720). The operations of 1725 may be performed in accordance with examples as disclosed herein. In some examples, aspects of the operations of 1725 may be performed by a channel information transmission component 930 as described with reference to FIG. 9.

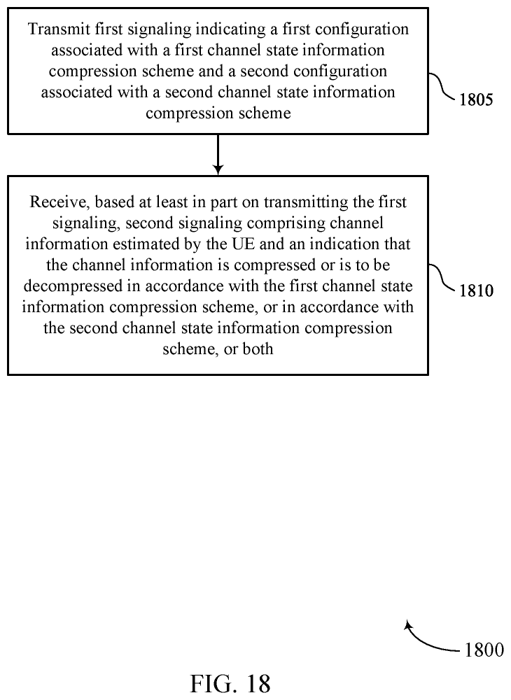

FIG. 18 shows a flowchart illustrating a method 1800 that supports techniques for channel state information and channel compression switching in accordance with one or more aspects of the present disclosure. The operations of the method 1800 may be implemented by a base station or its components as described herein. For example, the operations of the method 1800 may be performed by a base station 105 as described with reference to FIGS. 1 through 5 and 11 through 14. In some examples, a base station may execute a set of instructions to control the functional elements of the base station to perform the described functions. Additionally or alternatively, the base station may perform aspects of the described functions using special-purpose hardware.
At 1805, the method may include transmitting first signaling indicating a first configuration associated with a first channel state information compression scheme (e.g., a codebook-based channel state information compression scheme) and a second configuration associated with a second channel state information compression scheme (e.g., a neural network-based channel state information compression scheme). The operations of 1805 may be performed in accordance with examples as disclosed herein. In some examples, aspects of the operations of 1805 may be performed by a compression configuration transmission component 1325 as described with reference to FIG. 13.
At 1810, the method may include receiving, based on transmitting the first signaling, second signaling including channel information estimated by the UE and an indication that the channel information is compressed or is to be decompressed in accordance with the first channel state information compression scheme, or in accordance with the second channel state information compression scheme, or both. The operations of 1810 may be performed in accordance with examples as disclosed herein. In some examples, aspects of the operations of 1810 may be performed by a channel information reception component 1330 as described with reference to FIG. 13.

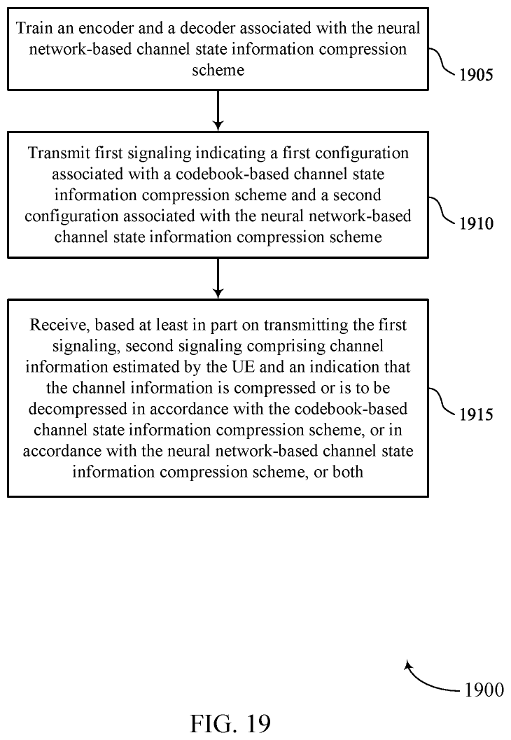

FIG. 19 shows a flowchart illustrating a method 1900 that supports techniques for channel state information and channel compression switching in accordance with one or more aspects of the present disclosure. The operations of the method 1900 may be implemented by a base station or its components as described herein. For example, the operations of the method 1900 may be performed by a base station 105 as described with reference to FIGS. 1 through 5 and 11 through 14. In some examples, a base station may execute a set of instructions to control the functional elements of the base station to perform the described functions. Additionally or alternatively, the base station may perform aspects of the described functions using special-purpose hardware.
At 1905, the method may include training an encoder and a decoder associated with a neural network-based channel state information compression scheme. The operations of 1905 may be performed in accordance with examples as disclosed herein. In some examples, aspects of the operations of 1905 may be performed by a compression scheme training component 1335 as described with reference to FIG. 13.
At 1910, the method may include transmitting first signaling indicating a first configuration associated with a codebook-based channel state information compression scheme and a second configuration associated with the neural network-based channel state information compression scheme. In some examples, the first signaling may include an indication a configuration of the trained encoder and a configuration of the trained decoder. The operations of 1910 may be performed in accordance with examples as disclosed herein. In some examples, aspects of the operations of 1910 may be performed by a compression configuration transmission component 1325 as described with reference to FIG. 13.
At 1915, the method may include receiving, based on transmitting the first signaling, second signaling including channel information estimated by the UE and an indication that the channel information is compressed or is to be decompressed in accordance with the codebook-based channel state information compression scheme, or in accordance with the neural network-based channel state information compression scheme, or both. The operations of 1915 may be performed in accordance with examples as disclosed herein. In some examples, aspects of the operations of 1915 may be performed by a channel information reception component 1330 as described with reference to FIG. 13.

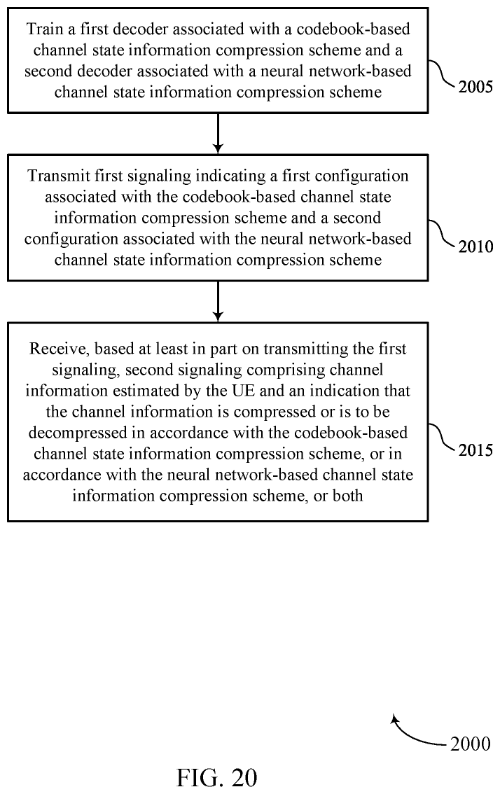

FIG. 20 shows a flowchart illustrating a method 2000 that supports techniques for channel state information and channel compression switching in accordance with one or more aspects of the present disclosure. The operations of the method 2000 may be implemented by a base station or its components as described herein. For example, the operations of the method 2000 may be performed by a base station 105 as described with reference to FIGS. 1 through 5 and 11 through 14. In some examples, a base station may execute a set of instructions to control the functional elements of the base station to perform the described functions. Additionally or alternatively, the base station may perform aspects of the described functions using special-purpose hardware.
At 2005, the method may include training a first decoder associated with a codebook-based channel state information compression scheme and a second decoder associated with a neural network-based channel state information compression scheme. The operations of 2005 may be performed in accordance with examples as disclosed herein. In some examples, aspects of the operations of 2005 may be performed by a compression scheme training component 1335 as described with reference to FIG. 13.
At 2010, the method may include transmitting first signaling indicating a first configuration associated with the codebook-based channel state information compression scheme and a second configuration associated with the neural network-based channel state information compression scheme. In some examples, the first signaling may indicate a configuration of the trained first decoder and a configuration of the trained second decoder. The operations of 2010 may be performed in accordance with examples as disclosed herein. In some examples, aspects of the operations of 2010 may be performed by a compression configuration transmission component 1325 as described with reference to FIG. 13.
At 2015, the method may include receiving, based on transmitting the first signaling, second signaling including channel information estimated by the UE and an indication that the channel information is compressed or is to be decompressed in accordance with the codebook-based channel state information compression scheme, or in accordance with the neural network-based channel state information compression scheme, or both. The operations of 2015 may be performed in accordance with examples as disclosed herein. In some examples, aspects of the operations of 2015 may be performed by a channel information reception component 1330 as described with reference to FIG. 13.

The following provides an overview of aspects of the present disclosure:
Aspect 1: A method for wireless communication at a UE, the method comprising: receiving first signaling indicating a first configuration associated with a first channel state information compression scheme and a second configuration associated with a second channel state information compression scheme; and transmitting, based at least in part on receiving the first signaling, second signaling comprising channel information estimated by the UE and an indication that the channel information is compressed, or is to be decompressed, in accordance with the first channel state information compression scheme, or in accordance with the second channel state information compression scheme, or both.
Aspect 2: The method of aspect 1, wherein the first channel state information compression scheme comprises a codebook-based channel state information compression scheme and the second channel state information compression scheme comprises a neural network-based channel state information compression scheme
Aspect 3: The method of either of aspects 1 or 2, further comprising: determining, using a neural network associated with the second channel state information compression scheme and based at least in part on the channel information, whether to compress the channel information, or to indicate to decompress the channel information, in accordance with the first channel state information compression scheme, or in accordance with the second channel state information compression scheme, or both.
Aspect 4: The method of any of aspects 1 through 3, the first signaling comprising a configuration of the neural network for determining whether to compress the channel information, or to indicate to decompress the channel information, in accordance with the first channel state information compression scheme, or in accordance with the second channel state information compression scheme, or both.
Aspect 5: The method of any of aspects 1 through 4, further comprising: determining a first mean squared error associated with a compression in accordance with the first channel state information compression scheme; determining a second mean squared error associated with a compression in accordance with the second channel state information compression scheme; and determining, based at least in part on a comparison between the first mean squared error and the second mean squared error, whether to compress the channel information, or to indicate to decompress the channel information, in accordance with the first channel state information compression scheme, or in accordance with the second channel state information compression scheme, or both.
Aspect 6: The method of any of aspects 1 through 5, further comprising: determining a first compression of the channel information based at least in part on the first channel state information compression scheme; determining a second compression of the channel information based at least in part on the second channel state information compression scheme; and determining, based at least in part on a cross-correlation between the first compression and the second compression, whether to compress the channel information, or to indicate to decompress the channel information, in accordance with the first channel state information compression scheme, or in accordance with the second channel state information compression scheme, or both.
Aspect 7: The method of any of aspects 1 through 6, the first signaling indicating a criteria for determining (e.g., for the UE to determine) whether to compress the channel information, or to indicate to decompress the channel information, in accordance with the first channel state information compression scheme, or in accordance with the second channel state information compression scheme, or both.
Aspect 8: The method of any of aspects 1 through 7, further comprising: training an encoder based at least in part on a first decoder indicated by the first configuration, or on a second decoder indicated by the second configuration, or both; and compressing the channel information based at least in part on the trained encoder.
Aspect 9: The method of any of aspects 1 through 7, further comprising: determining, based at least in part on a power consumption associated with the first channel state information compression scheme, a power consumption associated with the second channel state information compression scheme, or both, whether to compress the channel information, or to indicate to decompress the channel information, in accordance with the first channel state information compression scheme, or in accordance with the second channel state information compression scheme, or both.
Aspect 10: The method of any of aspects 1 through 9, further comprising: determining, based at least in part on a processing load associated with the first channel state information compression scheme, a processing load associated with the second channel state information compression scheme, or both, whether to compress the channel information, or to indicate to decompress the channel information, in accordance with the first channel state information compression scheme, or in accordance with the second channel state information compression scheme, or both.
Aspect 11: A method for wireless communication at a base station, the method comprising: transmitting first signaling indicating a first configuration associated with a first channel state information compression scheme and a second configuration associated with a second channel state information compression scheme; and receiving, based at least in part on transmitting the first signaling, second signaling comprising channel information estimated by the UE and an indication that the channel information is compressed, or is to be decompressed, in accordance with the first channel state information compression scheme, or in accordance with the second channel state information compression scheme, or both.
Aspect 12: The method of aspect 11, wherein the first channel state information compression scheme comprises a codebook-based channel state information compression scheme and the second channel state information compression scheme comprises a neural network-based channel state information compression scheme.
Aspect 13: The method of any of aspects 11 through 12, the first signaling indicating a criteria for determining (e.g., for the UE to determine) whether to compress the channel information, or to indicate to decompress the channel information, in accordance with the first channel state information compression scheme, or in accordance with the second channel state information compression scheme, or both.
Aspect 14: The method of any of aspects 11 through 13, the first signaling comprising a configuration of a neural network at the UE for determining whether to compress the channel information, or to indicate to decompress the channel information, in accordance with the first channel state information compression scheme, or in accordance with the second channel state information compression scheme, or both.
Aspect 15: The method of any of aspects 11 through 14, the second channel state information compression scheme associated with a smaller payload than the first channel state information compression scheme, or a greater degree of compression than the first channel state information compression scheme, or both.
Aspect 16: The method of any of aspects 11 through 15, further comprising: training an encoder and a decoder associated with the second channel state information compression scheme, the first signaling indicating a configuration of the trained encoder and a configuration of the trained decoder.
Aspect 17: The method of any of aspects 11 through 15, further comprising: training a first decoder associated with the first channel state information compression scheme and a second decoder associated with the second channel state information compression scheme, the first signaling indicating a configuration of the trained first decoder and a configuration of the trained second decoder.
Aspect 18: An apparatus for wireless communication at a UE, comprising a processor and memory coupled to the processor, the processor and memory configured to perform a method of any of aspects 1 through 10.
Aspect 19: An apparatus for wireless communication at a UE, comprising at least one means for performing a method of any of aspects 1 through 10.
Aspect 20: A non-transitory computer-readable medium storing code for wireless communication at a UE, the code comprising instructions executable by a processor to perform a method of any of aspects 1 through 10.
Aspect 21: An apparatus for wireless communication at a base station, comprising a processor and memory coupled to the processor, the processor and memory configured to perform a method of any of aspects 11 through 17.
Aspect 22: An apparatus for wireless communication at a base station, comprising at least one means for performing a method of any of aspects 11 through 17.
Aspect 23: A non-transitory computer-readable medium storing code for wireless communication at a base station, the code comprising instructions executable by a processor to perform a method of any of aspects 11 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled to the processor, the processor and memory configured to:
receive first signaling indicating a first configuration associated with a codebook-based channel state information compression scheme and a second configuration associated with a neural network-based channel state information compression scheme; and
transmit, based at least in part on receiving the first signaling, second signaling comprising channel information estimated by the UE and an indication that the channel information is compressed in accordance with the codebook-based channel state information compression scheme, or in accordance with the neural network-based channel state information compression scheme, or both.

2. The apparatus of claim 1, wherein the processor and memory are configured to:
determine, using a neural network associated with the neural network-based channel state information compression scheme and based at least in part on the channel information, whether to compress the channel information in accordance with the codebook-based channel state information compression scheme, or in accordance with the neural network-based channel state information compression scheme, or both.

3. The apparatus of claim 1, the first signaling comprising a configuration of the neural network for determining whether to compress the channel information in accordance with the codebook-based channel state information compression scheme, or in accordance with the neural network-based channel state information compression scheme, or both.

4. The apparatus of claim 1, wherein the processor and memory are configured to:
determine a first mean squared error associated with a compression in accordance with the codebook-based channel state information compression scheme;
determine a second mean squared error associated with a compression in accordance with the neural network-based channel state information compression scheme; and
determine, based at least in part on a comparison between the first mean squared error and the second mean squared error, whether to compress the channel information in accordance with the codebook-based channel state information compression scheme, or in accordance with the neural network-based channel state information compression scheme, or both.

5. The apparatus of claim 1, wherein the processor and memory are configured to:
determine a first compression of the channel information based at least in part on the codebook-based channel state information compression scheme;
determine a second compression of the channel information based at least in part on the neural network-based channel state information compression scheme; and
determine, based at least in part on a cross-correlation between the first compression and the second compression, whether to compress the channel information in accordance with the codebook-based channel state information compression scheme, or in accordance with the neural network-based channel state information compression scheme, or both.

6. The apparatus of claim 1, the first signaling indicating a criteria for the UE to determine whether to compress the channel information in accordance with the codebook-based channel state information compression scheme, or in accordance with the neural network-based channel state information compression scheme, or both.

7. The apparatus of claim 1, wherein the processor and memory are configured to:
train an encoder based at least in part on a first decoder indicated by the first configuration, or on a second decoder indicated by the second configuration, or both; and
compress the channel information based at least in part on the trained encoder.

8. The apparatus of claim 1, wherein the processor and memory are configured to:
determine, based at least in part on a power consumption associated with the codebook-based channel state information compression scheme, or a power consumption associated with the neural network-based channel state information compression scheme, or both, whether to compress the channel information in accordance with the codebook-based channel state information compression scheme, or in accordance with the neural network-based channel state information compression scheme, or both.

9. The apparatus of claim 1, wherein the processor and memory are configured to:
determine, based at least in part on a processing load associated with the codebook-based channel state information compression scheme, or a processing load associated with the neural network-based channel state information compression scheme, or both, whether to compress the channel information in accordance with the codebook-based channel state information compression scheme, or in accordance with the neural network-based channel state information compression scheme, or both.

10. The apparatus of claim 1, further comprising:
an antenna operable to receive the first signaling, or to transmit the second signaling, or both.

11. An apparatus for wireless communication at a base station, comprising:
a processor; and
memory coupled to the processor, the processor and memory configured to:
transmit first signaling indicating a first configuration associated with a codebook-based channel state information compression scheme and a second configuration associated with a neural network-based channel state information compression scheme; and
receive, based at least in part on transmitting the first signaling, second signaling comprising channel information estimated by the UE and an indication that the channel information is compressed in accordance with the codebook-based channel state information compression scheme, or in accordance with the neural network-based channel state information compression scheme, or both.

12. The apparatus of claim 11, the first signaling indicating a criteria for the UE to determine whether to compress the channel information in accordance with the codebook-based channel state information compression scheme, or in accordance with the neural network-based channel state information compression scheme, or both.

13. The apparatus of claim 11, the first signaling comprising a configuration of a neural network at the UE for determining whether to compress the channel information in accordance with the codebook-based channel state information compression scheme, or in accordance with the neural network-based channel state information compression scheme, or both.

14. The apparatus of claim 11, the neural network-based channel state information compression scheme associated with a smaller payload than the codebook-based channel state information compression scheme, or a greater degree of compression than the codebook-based channel state information compression scheme, or both.

15. The apparatus of claim 11, wherein the processor and memory are configured to:
train an encoder and a decoder associated with the neural network-based channel state information compression scheme, the first signaling indicating a configuration of the trained encoder and a configuration of the trained decoder.

16. The apparatus of claim 11, wherein the processor and memory are configured to:
train a first decoder associated with the codebook-based channel state information compression scheme and a second decoder associated with the neural network-based channel state information compression scheme, the first signaling indicating a configuration of the trained first decoder and a configuration of the trained second decoder.

17. The apparatus of claim 11, further comprising:
an antenna operable to transmit the first signaling, or to receive the second signaling, or both.

18. A method for wireless communication at a user equipment (UE), the method comprising:
receiving first signaling indicating a first configuration associated with a codebook-based channel state information compression scheme and a second configuration associated with a neural network-based channel state information compression scheme; and
transmitting, based at least in part on receiving the first signaling, second signaling comprising channel information estimated by the UE and an indication that the channel information is compressed in accordance with the codebook-based channel state information compression scheme, or in accordance with the neural network-based channel state information compression scheme, or both.

19. The method of claim 18, further comprising:
determining, using a neural network associated with the neural network-based channel state information compression scheme and based at least in part on the channel information, whether to compress the channel information in accordance with the codebook-based channel state information compression scheme, or in accordance with the neural network-based channel state information compression scheme, or both.

20. The method of claim 19, the first signaling comprising a configuration of the neural network for determining whether to compress the channel information in accordance with the codebook-based channel state information compression scheme, or in accordance with the neural network-based channel state information compression scheme, or both.

21. The method of claim 18, further comprising:
determining a first mean squared error associated with a compression in accordance with the codebook-based channel state information compression scheme;
determining a second mean squared error associated with a compression in accordance with the neural network-based channel state information compression scheme; and
determining, based at least in part on a comparison between the first mean squared error and the second mean squared error, whether to compress the channel information in accordance with the codebook-based channel state information compression scheme, or in accordance with the neural network-based channel state information compression scheme, or both.

22. The method of claim 18, further comprising:
determining a first compression of the channel information based at least in part on the codebook-based channel state information compression scheme;
determining a second compression of the channel information based at least in part on the neural network-based channel state information compression scheme; and
determining, based at least in part on a cross-correlation between the first compression and the second compression, whether to compress the channel information in accordance with the codebook-based channel state information compression scheme, or in accordance with the neural network-based channel state information compression scheme, or both.

23. The method of claim 18, the first signaling indicating a criteria for the UE to determine whether to compress the channel information in accordance with the codebook-based channel state information compression scheme, or in accordance with the neural network-based channel state information compression scheme, or both.

24. The method of claim 18, further comprising:
training an encoder based at least in part on a first decoder indicated by the first configuration, or on a second decoder indicated by the second configuration, or both; and
compressing the channel information based at least in part on the trained encoder.

25. The method of claim 18, further comprising:
determining, based at least in part on a power consumption associated with the codebook-based channel state information compression scheme, or a power consumption associated with the neural network-based channel state information compression scheme, or both, whether to compress the channel information in accordance with the codebook-based channel state information compression scheme, or in accordance with the neural network-based channel state information compression scheme, or both.

26. A method for wireless communication at a base station, the method comprising:
transmitting first signaling indicating a first configuration associated with a codebook-based channel state information compression scheme and a second configuration associated with a neural network-based channel state information compression scheme; and
receiving, based at least in part on transmitting the first signaling, second signaling comprising channel information estimated by the UE and an indication that the channel information is compressed in accordance with the codebook-based channel state information compression scheme, or in accordance with the neural network-based channel state information compression scheme, or both.

27. The method of claim 26, the first signaling indicating a criteria for the UE to determine whether to compress the channel information in accordance with the codebook-based channel state information compression scheme, or in accordance with the neural network-based channel state information compression scheme, or both.

28. The method of claim 26, the first signaling comprising a configuration of a neural network at the UE for determining whether to compress the channel information in accordance with the codebook-based channel state information compression scheme, or in accordance with the neural network-based channel state information compression scheme, or both.

29. The method of claim 26, further comprising:
training an encoder and a decoder associated with the neural network-based channel state information compression scheme, the first signaling indicating a configuration of the trained encoder and a configuration of the trained decoder.

30. The method of claim 26, further comprising:
training a first decoder associated with the codebook-based channel state information compression scheme and a second decoder associated with the neural network-based channel state information compression scheme, the first signaling indicating a configuration of the trained first decoder and a configuration of the trained second decoder.
